SEQUENCE LISTING (6 sequences)

SEQ ID NO: 1 - DNA, 50 bp, Artificial Sequence
  synthetic construct
acacaaaaatcgaggtggctcagtttgtgaaagacctgctgctgcacctg

SEQ ID NO: 2 - DNA, 50 bp, Artificial Sequence
  synthetic construct
gcacagaggagctttctgattctgtgtgatattcaccagctcctcgatca

SEQ ID NO: 3 - DNA, 50 bp, Artificial Sequence
  synthetic construct
tttttttttttttttttttttttttttttttttttttttttttttttttt

SEQ ID NO: 4 - DNA, 50 bp, Artificial Sequence
  synthetic construct
agttcaccgttccgctgctggaaccgcacctggacccggaagcggcggaa

SEQ ID NO: 5 - DNA, 50 bp, Artificial Sequence
  synthetic construct
ccagtcttctccggaaatcgacgaagaccgtatcccgaacccgcacctga

SEQ ID NO: 6 - DNA, 50 bp, Artificial Sequence
  synthetic construct
agcaggcggttgaagtttggcagggtctggcgctgctgtctgaagcggtt

(19) United States
(12) Patent Application Publication
(10) Pub. No.: US 2004/0223885 A1
(43) Pub. Date: Nov. 11, 2004

(54) Apparatus for the automated synthesis of polynucleotides

(76) Inventors: Randy E. Keen, Santaluz, CA (US); Alan Koder, Poway, CA (US); David Evans, El Cajon, CA (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/431,627

(22) Filed: May 6, 2003

(51) Int. Cl. B01L 3/00

(52) U.S. Cl. 422/99; 422/130

(57) ABSTRACT

The invention provides an apparatus for maintaining a closed continuous anhydrous system for automated polynucleotide synthesis, having a) a plurality of moisture-resistant reagent containers, b) a dry box capable of forming a seal over a synthesis platform of an automated polynucleotide synthesizer, c) moisture-resistant tubing connecting the reagent containers to the dry box, d) a reagent gas feed connecting the reagent containers to a gas, where the gas pressurizes the reagent containers, and e) a digital gas regulator connected to the reagent gas feed, where the gas regulator maintains constant pressure in the reagent containers.

### BACKGROUND OF THE INVENTION

This invention relates generally to biopolymer synthesis and, more specifically, to devices for the automated synthesis of high quality polynucleotides using anhydrous conditions.

Many techniques in modern molecular biology employ synthetic polynucleotides, including the polymerase chain reaction (PCR), DNA sequencing, site directed mutagenesis, whole gene assembly, and single-nucleotide polymorphism (SNP) analysis. Unlike many other reagents used in molecular biology, polynucleotides are not generally available as stock items but are custom made to each user's specification. For example, the sequence, scale, purity, and modifications of a polynucleotide can be specified by the user.

Improvements in polynucleotide synthesis chemistry and processing technology have lead to more rapid synthesis at a lower cost. However, polynucleotide synthesis remains a complex, multi-step process that requires a series of high efficiency chemical reactions. Ideally, the sequential addition or coupling of each nucleotide in a final polynucleotide product would occur with 100% efficiency resulting in 100% yields. The yield refers to the amount of final product that is recovered at each step or at the end of the complete synthesis procedure. However, coupling efficiency is less than 100% and a small decrease at each step can result in substantial decreases in the yield of the final polynucleotide product because the effects of coupling efficiency will be additive. Even a small drop in coupling efficiency, for example, from 99% to 98.5% or 98%, will have a significant negative impact on the yield of the final polynucleotide.

The yield at each step in the synthesis of a polynucleotide also determines the length of the polynucleotide that can be made. Since the yield of polynucleotide decreases at each step, there is a point where there is not enough material to continue the synthesis reaction. For example, if coupling efficiency is 99%, the yield of full-length polynucleotide product present after synthesis will be about 83% for a polynucleotide containing 20 nucleotides, 61% for a polynucleotide containing 50 nucleotides, 48% for a polynucleotide containing 75 nucleotides and 37% for a polynucleotide containing 100 nucleotides. If, for example, the coupling efficiency is 98%, the yield for a polynucleotide containing 100 nucleotides drops to 13%. Therefore, it has been difficult to economically synthesize high quality polynucleotides containing greater than 100 nucleotides.

Another problem in the synthesis of polynucleotides is the presence of contaminants in the final polynucleotide product. Contaminants can include precursor reagents and solvents from the synthesis reaction as well as partial polynucleotides that are less than the full length of the desired polynucleotide product. These partial polynucleotides are the result of inefficient coupling of nucleotides during the synthesis procedure and often they are removed by a purification step prior to use of the final polynucleotide product in subsequence applications. Purification of the final polynucleotide product from the partial polynucleotides or from other contaminants is time consuming and results in a decreased yield of the final polynucleotide product.

It is desirable to have polynucleotides of high quality and long length for certain applications. For example, full genes can be assembled by overlapping synthetic polynucleotides such that a complete gene is generated. For such gene assembly applications, longer polynucleotides are desirable to reduce the number of steps, and therefore the amount of time, required to assemble the complete gene. High quality polynucleotides are needed for such procedures since the effect of contaminants in the sequential assembly reactions, such as decreased annealing efficiency, will be additive. In addition, high quality polynucleotides are needed in order to prevent the introduction of unwanted mutations into an assembled gene sequence.

Thus, there exists a need for a device which allows for the rapid synthesis of high quality polynucleotides, for example, as raw materials suitable for synthetic gene production. The present invention satisfies this need and provides related advantages as well.

### SUMMARY OF THE INVENTION

The invention provides an apparatus for maintaining a closed continuous anhydrous system for automated polynucleotide synthesis, having a) a plurality of moisture-resistant reagent containers, b) a dry box capable of forming a seal over a synthesis platform of an automated polynucleotide synthesizer, c) moisture-resistant tubing connecting the reagent containers to the dry box, d) a reagent gas feed connecting the reagent containers to a gas, where the gas pressurizes the reagent containers, and e) a digital gas regulator connected to the reagent gas feed, where the gas regulator maintains constant pressure in the reagent containers. The invention further provides an apparatus for maintaining a closed continuous anhydrous system for automated polynucleotide synthesis, having a) a plurality of moisture-resistant reagent containers, b) a dry box capable of forming a seal over a synthesis platform of an automated polynucleotide synthesizer, c) moisture-resistant tubing connecting the reagent containers to the dry box, d) a reagent gas feed connecting the reagent containers to a gas, where the gas pressurizes the reagent containers, e) a digital gas regulator connected to the reagent gas feed, where the gas regulator maintains constant pressure in the reagent containers, and f) a polynucleotide synthesizer device.

### BRIEF DESCRIPTION OF THE DRAWINGS

FIG. 1 shows an apparatus for the automated synthesis of polynucleotides. The apparatus in FIG. 1 shows reagent containers for nucleotides (1-6), reagent containers for synthesis solutions (7-11), a dry box (12) with glass viewing windows (109, 110, 111), a scaffold for a chemical injection device (13) with individual solenoid valves (118, 119) which connect reagent bottles to the synthesis plate, flow-through gas dryers connected to the dry box input and output (14, 15), flow-through gas dryers located in the reagent gas feed used to pressurize the nucleotide reagent containers and wash solution containers (16, 17), gas inlets to the dry box (18, 19), an inlet port (20) to a flow-through gas dryer (17) and an outlet port (21) to a flow-through gas dryer (17), digital gas regulators (22, 23), an in-line solenoid valve (24) from the synthesis plate to organic waste container, scaffolding for the top of the apparatus (105), for the bottom of the apparatus (115), for synthesis solution reagent containers (106, 107) and for nucleotide reagent containers (108), a computer (112), a comptroller box that controls the values (113), a kill switch to turn off the comptroller (114), a table top (116), and part of a board that holds solenoid values (117, shown in more detail in FIGS. 3 and 4).

FIG. 2 shows multiple views of the apparatus shown in FIG. 1. FIG. 2A is a top view, FIG. 2B is a side angle view, FIG. 2C is a front view, FIG. 2D is an side view. Parts of the apparatus are labeled as in FIG. 1. Note in FIG. 2D reagent containers for synthesis solutions 7 and 8 and reagent containers for nucleotides 1, 2, and 3 have been removed to show reagent container for synthesis solutions 9, 10, and 11 and reagent containers for nucleotides 4, 5, and 6 which are located on the right side of the apparatus.

FIG. 3 shows a close-up view of the apparatus shown in FIG. 1. Parts of the apparatus are labeled as in FIG. 1. FIG. 3 shows a more detailed view of a board that holds solenoid values (117) and solenoid values (26-31).

FIGS. 4A and 4B show a close-up view of the apparatus shown in FIG. 1 pointing out the location of in-line solenoid valves (24, 25) from the synthesis plates to organic waste containers and vacuum inlet solenoid valves (26, 27) to organic waste containers as well as other solenoid valves (28-31). FIG. 4A also shows a dry box (12) with glass viewing windows (111 and 121).

FIG. 5 shows a close-up view of a dry box environment gas flow. The boiloff from the liquid nitrogen dewar can be used for dry box gas purge. The diagram shows a liquid nitrogen dewar (38) and gas regulator (39), a gas dryer from FIG. 1 (16) with gas outlet and inlet ports (32, 33), tubing (40) connecting the liquid nitrogen dewar and gas regulator (38, 39) to a lower gas dryer inlet port (33) and tubing (41) connecting an upper gas dryer outlet port (32) to a main gas control solenoid valve (28). Tubing (42) connects a main gas control (28) to a high flow control solenoid valve (30) and tubing (44) connects a high flow control solenoid valve (30) to a high flow flow meter (37) and tubing (46) connects a high flow flow meter (37) to a three-way connector (48). Tubing (43) connects a main gas control solenoid valve (28) to a low flow control solenoid valve (31) and tubing (45) connects a low flow control solenoid valve (31) to a low flow flow meter (36) and tubing (47) connects a low flow flow meter (36) to a three-way connector (48). Tubing (49) connects a three-way connector (48) to a three-way connector (50). Tubing (52) connects a three-way connector (50) to a gas inlet port (18) and tubing (51) connects a three-way connector (50) to a gas inlet port (19). Tubing (54) connects a gas outlet port (35) to a three-way connector (55) and tubing (53) connects a gas outlet port (34) to a three-way connector (55). Gas inlet and outlet ports (18, 19, 34, and 35) are connected to a dry box (12). Tubing (56) connects a three-way connector (55) to a gas inlet port (20) on a gas dryer (17) and tubing (57) connects a gas outlet port (21) on a gas dryer (17) to the atmosphere for venting.

FIG. 6 shows a close-up view of a reagent bottle pressure system. The diagram shows a regulated helium gas supply (58) and gas regulator (59), tubing (60) connecting a regulated helium gas supply and gas regulator (58, 59) and a gas inlet port (61) on a gas dryer (15). Tubing (62) connects a gas outlet port (62) on a gas dryer (15) with a inlet port (64) on a digital gas regulator (22). Tubing (65) connects a digital gas regulator (22) with a three-way connector (66). Tubing (67) connects a three-way connector (66) with a gas supply manifold (69) and tubing (68) connects a three-way connector (66) with a gas supply manifold (70). The gas supply manifolds feed each reagent bottle (not shown on FIG. 1).

FIG. 7 shows a close-up view of an acetonitrile (ACN) wash system. The diagram shows a regulated helium gas supply (71) and gas regulator (72), tubing (73) connecting a regulated helium gas supply and gas regulator (71,72) and a gas inlet port (74) on a gas dryer (14). Tubing (76) connects a gas outlet port (75) on a gas dryer (14) with a inlet port (77) on a digital gas regulator (23). Tubing (78) connects a digital gas regulator (23) with an acetonitrile dewar (79). Tubing (80) connects an acetonitrile dewar (79) with a three-way connector (81). Tubing (82) connects a three-way connector (81) with a solenoid valve wash line manifold (83) and tubing (84) connects a three-way connector (81) with a solenoid valve wash line manifold (85).

FIG. 8 shows a close-up view of a vacuum system. The diagram shows tubing (87) connecting a waste container (86) with a solenoid valve (25) and tubing (88) connecting a solenoid valve (25) with a synthesis plate (plate 1) (89). The diagram also shows tubing (100) connecting a waste container (99) with a solenoid valve (24) and tubing (101) connecting a solenoid valve (24) with a synthesis plate (plate 2) (102). Tubing (90) connects a waste container (86) with a three-way vacuum inlet solenoid valve (26) and tubing (91) connects a three-way vacuum inlet solenoid valve (26) with a dry Teflon vacuum pump (93) and trap (92). Tubing (103) connects a waste container (99) with a three-way vacuum inlet solenoid valve (27) and tubing (104) connects a three-way vacuum inlet solenoid valve (27) with a dry Teflon vacuum pump and trap (92,93). Tubing (95) connects a drain waste container (96) with a drain (94) and tubing (97) connects a drain waste container (96) with a vacuum inlet solenoid valve (29). Tubing (98) connects a vacuum inlet solenoid valve (29) with a dry Teflon vacuum pump and trap (92,93).

FIG. 9 shows a MALDI-TOF Mass Spectrometry (Sequenom Inc.) spectra of unpurified 50-mer CNT4-F-8 5′ ACACAAAAATCGAGGTGGCTCAGTTTGTGAAAGACCTGCTGCTGCACCTG 3′ (SEQ ID NO: 1) polynucleotide synthesized on the apparatus shown in FIG. 1.

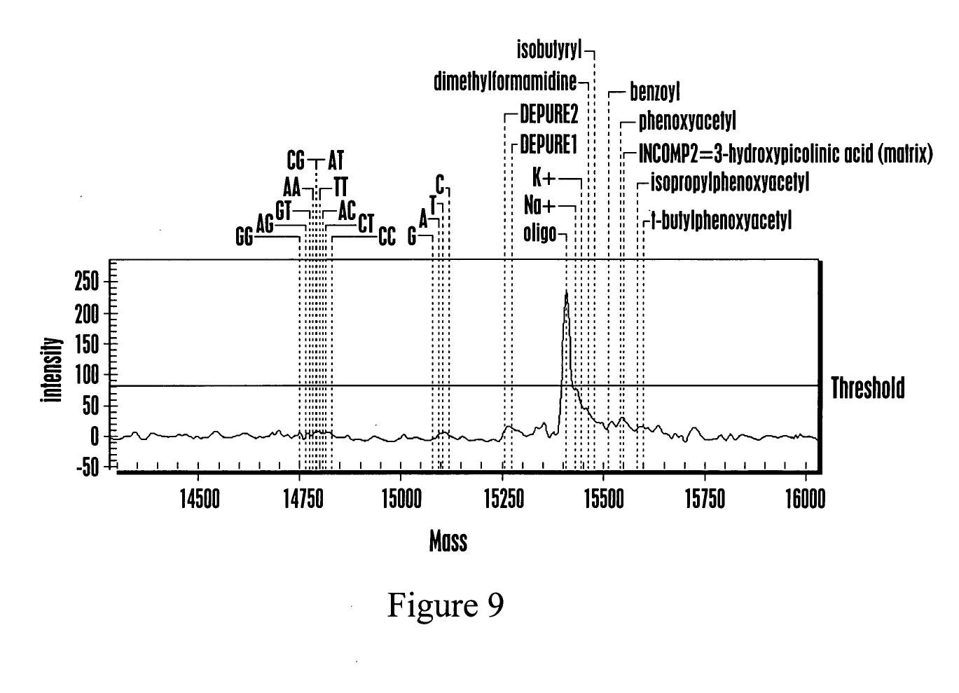

FIG. 10 shows a MALDI-TOF Mass Spectrometry (Sequenom Inc.) spectra of unpurified 50-mer CNT4-R-3 5′ GCACAGAGGAGCTTTCTGATTCTGTGTGATATTCACCAGCTCCTCGATCA 3′ (SEQ ID NO:2) polynucleotide synthesized on the apparatus shown in FIG. 1.

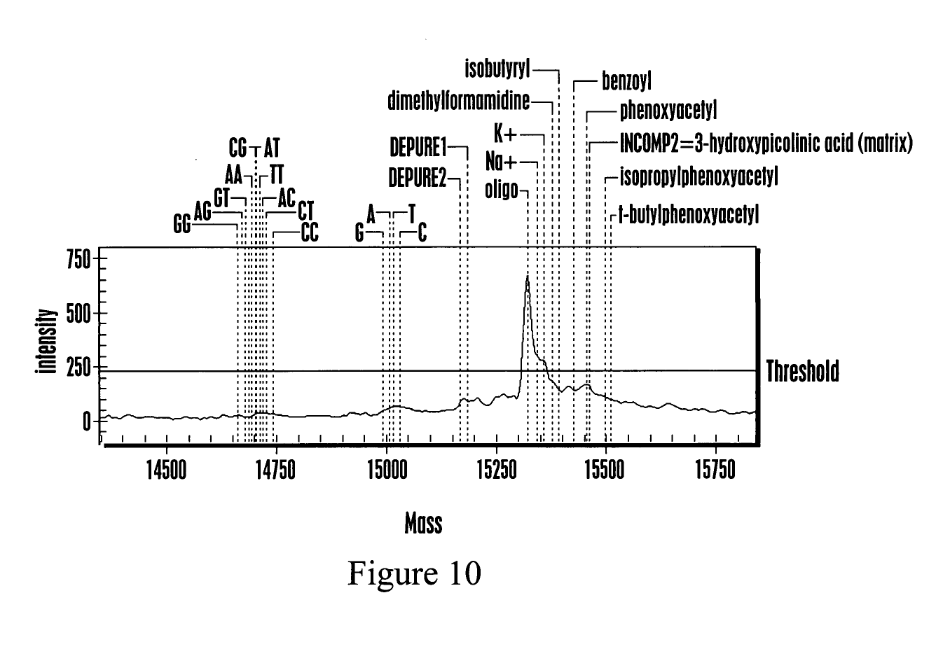

FIG. 11 shows a MALDI-TOF Mass Spectrometry (Sequenom Inc.) spectra of polyacrylamide gel electrophoresis (PAGE) purified and desalted 50-mer polyT 5′TTTTTTTTTTTTTTTTTTTTTTTTTTTTTTTTTTTTTTTTTTTTTTTTTT (SEQ ID NO:3) polynucleotide obtained commercially from Qiagen Inc.

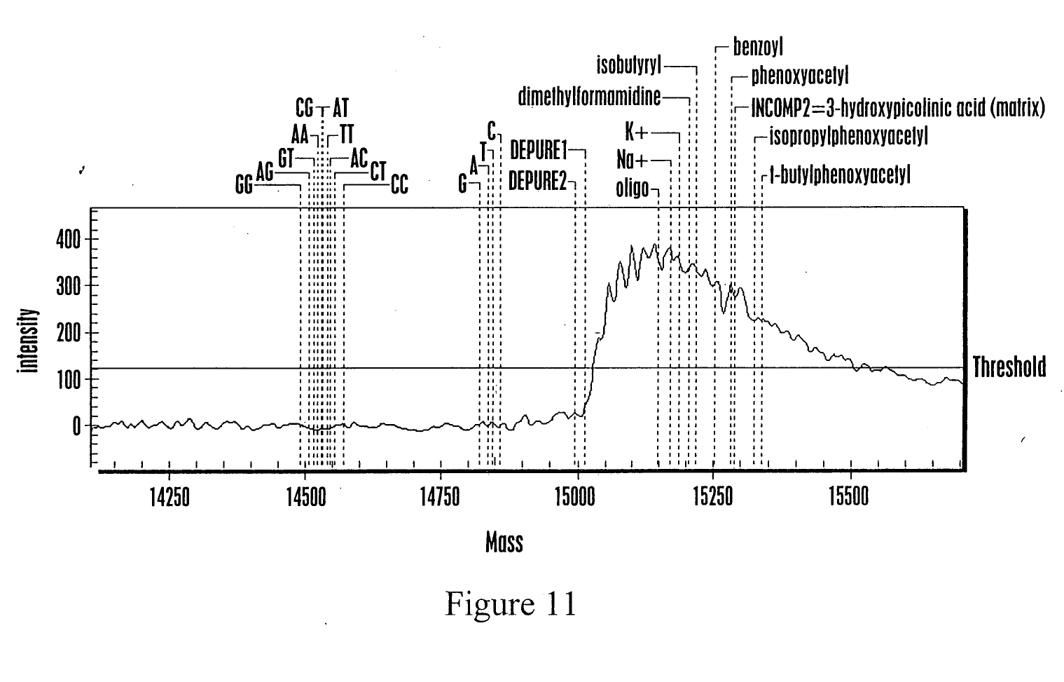

FIG. 12 shows a MALDI-TOF Mass Spectrometry (Sequenom Inc.) spectra of PAGE purified and desalted 50-mer IPP1_F4 5′ AGTTCACCGTTCCGCTGCTGGAACCGCACCTGGACCCGGAAGCGGCGGAA 3′ (SEQ ID NO:4) polynucleotide obtained commercially from Integrated DNA Technologies Inc.

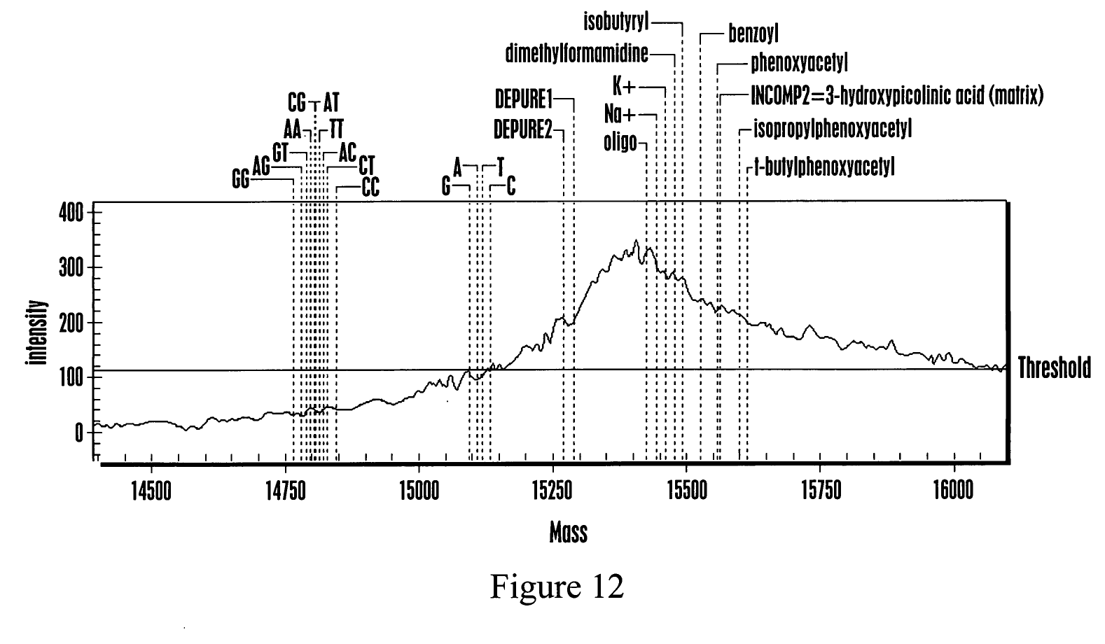

FIG. 13 shows a MALDI-TOF Mass Spectrometry (Sequenom Inc.) spectra of PAGE purified and desalted 50-mer IPP1_F6 5′CCAGTCTTCTCCGGAAATCGACGAAGACCGTATCCCGAACCCGCACCTGA 3′ (SEQ ID NO:5) polynucleotide obtained commercially from Integrated DNA Technologies Inc.

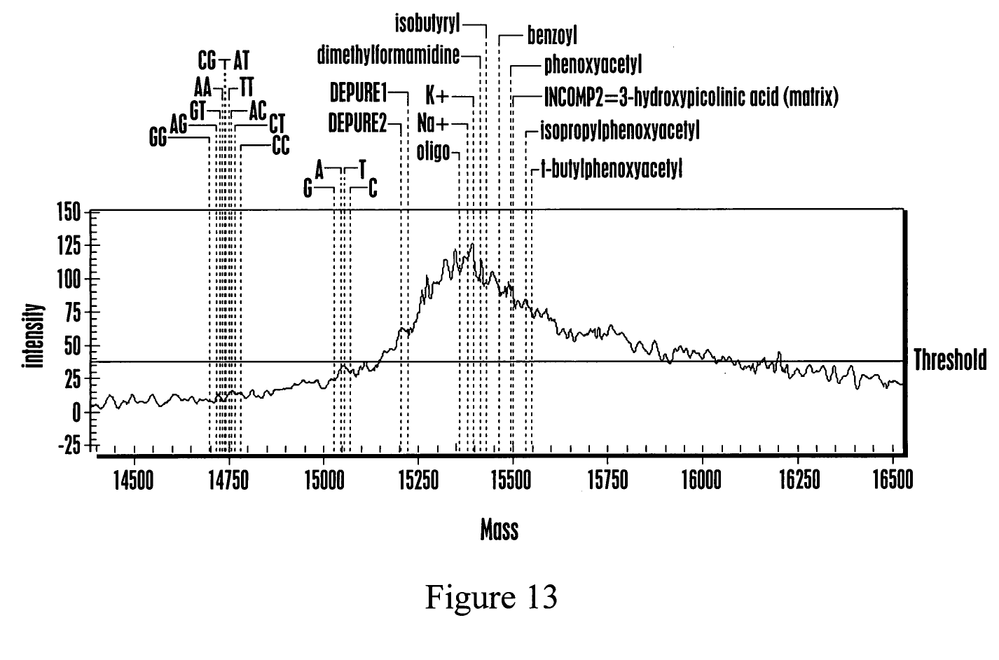

FIG. 14 shows a MALDI-TOF Mass Spectrometry (Sequenom Inc.) spectra of unpurified EPO_{—}001_F-7 5′ AGCAGGCGGTTGAAGTTTGGCAGGGTCTGGCGCTGCTGTCTGAAGCGGTT (SEQ ID NO:6) polynucleotide generated at Egea Biosciences using a commercial BioAutomation Mermade™ oligonucleotide synthesizer.

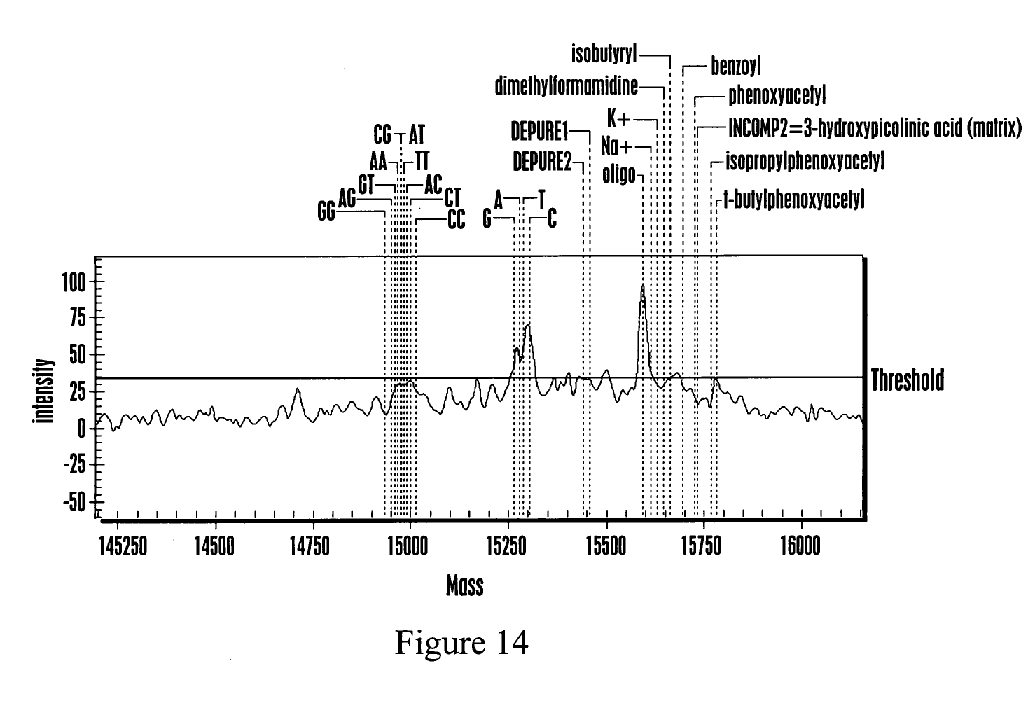

### DETAILED DESCRIPTION OF THE INVENTION

This invention provides an apparatus for the automated synthesis of biopolymers such as polynucleotides. The apparatus controls the synthesis environment allowing more efficient synthesis reactions and resulting in higher quality synthesis products. For example, the apparatus can maintain a closed continuous system for automated polynucleotide synthesis and contains reagent containers, a dry box that can form a seal over a synthesis platform of an automated polynucleotide synthesizer, tubing, and at least one digital gas regulator connected to a reagent gas feed. An apparatus of the invention can contain connections that are sealed to exclude moisture entry. In addition, an apparatus of the invention can further contain at least one flow through gas dryer. An apparatus of the invention can be used in conjunction with a polynucleotide synthesizer device or other automated biopolymer synthesis device in order to increase the efficiency of the synthesis reaction generating higher quality in the resulting synthesis products.

In one embodiment, the invention provides an apparatus containing reagent containers, a dry box that can form a seal over synthesis reaction chambers or a synthesis platform of an automated polynucleotide synthesizer, moisture-resistant tubing, at least one digital gas regulator connected to a reagent gas feed, and a polynucleotide synthesizer device.

An apparatus of the invention regulates the synthesis environment to optimize conditions for highly efficient synthesis. For example, an apparatus of the invention can maintain a closed continuous anhydrous system for automated polynucleotide synthesis. An advantage of such an apparatus is that humidity is decreased during the polynucleotide synthesis reactions. A reduction in humidity or moisture within the automated polynucleotide synthesis system results in increased coupling efficiency. Increased coupling efficiency results in greater yields at each step and the ability to synthesize longer polynucleotides. Increased coupling efficiency also reduces the amount of partial polynucleotide products which increases the quality of the final polynucleotide product.

Another advantage of an apparatus of the invention is that the apparatus can regulate pressure stability. Stable pressure can reduce variation in the delivery of chemicals in the synthesis reaction. For example, as the synthesis reaction continues, there is a drop in reagent container volume and gas pressure in high pressure gas cylinders of high purity gas which results in a concominant drop in pressure. This drop in pressure can result in a change in the amount of reagent that is delivered in the synthesis reaction which can reduce coupling efficiency. Components of an apparatus of the invention, such as the digital gas regulator, can monitor gas pressure in real time and can react resulting in the equalization of pressure to a more constant level. The maintenance of constant pressure results in more consistent delivery of the correct amount of reagent in the synthesis reaction which results in better coupling efficiency. Maintaining constant pressure in the system also aids in reducing relative humidity in the system.

An apparatus of the invention can regulate or control a homeostatic state, for example, with low moisture content and a steady pressure level for the consistent delivery of chemical reagents. Both the decrease in humidity and decrease in variation in chemical delivery can result in higher coupling efficiency which allows for the production of polynucleotides of longer length and higher quality. Polynucleotides of high quality can be used without a purification step. Purification steps are time consuming, labor intensive, and result in lower yield of the final product. Polynucleotides of long length or high quality are useful in several applications including, for example, gene assembly and site-directed mutagenesis.

As used herein, “polynucleotide” is intended to mean two or more nucleotides linked together through a covalent bond. For example, nucleotides can be linked together through a phosphodiester bond. A polynucleotide can contain the four nucleotides adenine, guanine, cytosine, and thymine or nucleotide analogues and derivatives such as inosine, dideoxynucleotides or thiol derivatives of nucleotides. Different chemical forms of nucleotides such as nucleosides or phosphoramidites can be used to generate a polynucleotide. In addition, nucleotides can further incorporate a detectable moiety such as a radiolabel, a fluorochrome, a ferromagnetic substance, a luminescent tag or a detectable moiety such as biotin. Polynucleotides also include, for example, RNA and peptide nucleic acids (PNAs).

As used herein, the term “closed continuous system” is intended to mean a system that can monitor and regulate a variable in the system over time in such a way that maintains homeostasis for an optimized synthesis environment. Monitoring and regulating a variable over time is intended to mean that the variable is monitored and regulated contemporaneously or in “real time.” The desired homeostatic state can be set by the user, for example, in terms of the percent of moisture in the system or by other measures such as the amount of pressure in the system. For example, a closed continuous system can be an enclosed area where the amount of pressure is constantly monitored and adjusted to maintain a regulated amount of pressure in the system.

As used herein, the term “closed continuous anhydrous system” is intended to mean a system that can monitor and react to the amount of moisture in the system in contemporaneously in such a way that maintains homeostasis. The desired homeostatic state can be set by the user in terms of the percent of moisture or humidity in the system. For example, a closed continuous anhydrous system can be an enclosed area where the amount of moisture is constantly monitored and adjusted to exclude as much moisture as possible from the system. In addition, for example, other variables can be regulated in a closed continuous anhydrous system such as pressure levels.

The term anhydrous is intended to mean a low water content. Water content can be measured in several ways, for example, as percent of humidity using a humidity meter. An anhydrous system can have a low level of humidity or moisture. For example, an anhydrous system can have 5% relative humidity (RH) or less, 4% relative humidity or less, 3% relative humidity or less, 2% relative humidity or less, 1% relative humidity or less, 0.5% relative humidity or less, or no detectable relative humidity. Water content can also be measured in parts per million (ppm) units. For example, the water content in an organic solvent can be 10 ppm or less for anhydrous organic solvents.

As used herein, “reagent” is intended to mean a substance used in a chemical reaction to detect, examine, measure, or produce other substances. When a reagent is used in the production of a desired substance, such as a polynucleotide, the reagent can be used at any stage in the production of the desired substance. For example, a reagent can be a precursor such as a nucleotide-solution which is used at the beginning of the production of a polynucleotide. In addition, a reagent can be a solution used later in the production of a polynucleotide such as a wash solution that is used to wash away un-bound nucleotides. For example, an acetonitrile wash solution is a reagent that can be used in the production of polynucleotides. Reagents include, for example, amidites, deblock, oxidizer, activator, capping reagents, and acetonitrile wash solution.

As used herein, the term “moisture-resistant” is intended to mean a substance that is impermeable to moisture. Moisture is diffuse wetness that can be felt as vapor in the atmosphere or as condensed liquid on the surfaces of objects. Several moisture-resistant materials are known to those skilled in the art and include both natural and synthetic materials. For example, stainless steel, polypropylene, polystyrene and Teflon are moisture-resistant materials.

As used herein the term “dry box” is intended to mean a hood that is capable of forming a chamber over a synthesis platform of an automated polynucleotide synthesizer. The dry box is a hood with one open horizontal surface such that the dry box forms a closed chamber when sealed to a surface of sufficient size. A dry box can be made of a moisture-resistant material such as a plastic, glass, polymers, elastomers, or stainless steel.

As used herein, the term “reagent gas feed” is intended to mean a tubing capable of carrying a gas from a gas source to a reagent container. The reagent gas feed is made of material that can withstand the desired pressure level. For example, a reagent gas feed can be plastic, stainless steel, or Teflon tubing that connects a gas cylinder with a wash solution container. Various types of tubing can be used for the reagent gas feed, for example, the tubing can have different levels of flexibility or different diameters so long as the tubing is capable of carrying a gas from a gas source to a reagent container.

As used herein, the term “digital gas regulator” is intended to mean a device that monitors gas pressure accurately over time and is capable of sending an output signal to a device which functions to adjust gas pressure to a desired level. A digital gas regulator can be set to monitor gas pressure and maintain a constant level of gas pressure in a system. For example, a digital gas regulator can monitor the level of gas pressure in a pressurized reagent container, high pressure gas cylinder, or closed system such that, when the level of reagent in the container changes or pressure in the gas cylinder changes, the resulting change in pressure in the container is accurately monitored by the digital gas regulator and shown on a digital display. The digital gas regulator can then send a signal to a valve that controls the amount of gas that enters the reagent container adjusting the amount of gas entering the container to equalize the gas pressure in the container. In this way a continuous homeostatic system is maintained. A digital signal allows for more accurate adjustment of gas pressure than the use of an analog signal. Hence a digital signal allows for contemporaneous adjustment of gas pressure. A digital gas regulator can be used to maintain gas pressure, for example, at increments of 0.1 psi pressure, 0.05 psi pressure, or 0.01 psi pressure. The more accurate the gas regulator, the more accurate the control of pressure within the system. Digital gas regulators are commercially available, for example, from Alicat Scientific.

As used herein, the term “synthesis platform” of an automated polynucleotide synthesizer is intended to mean the surface of an automated polynucleotide synthesizer that contains or can hold a reaction vessel or chamber, or vessels or chambers where the polynucleotide synthesis occurs. For example, the synthesis platform can contain one or more wells or columns or plates where the polynucleotide synthesis reaction can occur. Several automated polynucleotide synthesizer are commercially available. For example, the Applied Biosystems ABI 381A and Perseptive Biosystems 8905 are standard polynucleotide synthesizers that are commercially available. Also, for example, a polynucleotide synthesizer can be a custom made synthesizer such as the MerMade polynucleotide synthesizer (see Rayner et al., Genome Research 8:741-747 (1998), which is incorporated herein by reference).

As used herein, the term “flow through gas dryer” is intended to mean a drying device that is situated in line with a connector such as tubing so that the material in the connector can flow through the drying device. The drying device can be any device that removes moisture from the material in the connector. For example, the drying device can contain a dessicant material which dries the material in the connector. Several dessicant material can be used and are known in the art, for example, 5A molecular sieves and DRIERITE. A dessicant material such as DRIERITE can dry gasses to a dryness of 0.005 mg/l of air. The indicator color in DRIERITE changes from blue to pink upon exhaustion.

The invention provides an apparatus for maintaining a closed continuous system for automated polynucleotide synthesis. An apparatus of the invention can have several reagent containers; a dry box capable of forming a seal over a synthesis platform of an automated polynucleotide synthesizer; moisture-resistant tubing connecting the reagent containers to the dry box; a reagent gas feed connecting the reagent containers to a gas, and a digital gas regulator connected to the reagent gas feed. When tubing is in locations within the apparatus that are in contact with solvents, the moisture-resistant tubing chosen is also solvent-resistant. Several materials that are resistant to different solvents are known in the art.

An apparatus of the invention creates a controlled environmental chamber for optimizing synthesis of biopolymers such as oligonucleotides. The closed continuous system can regulate a variable in the system such as pressure. In one embodiment, the apparatus contains connectors that are sealed with silicone caulk. In another embodiment, the sealed connections can maintain a pressure of greater than 100 pounds per square inch (psi).

Methods for synthesizing polynucleotides (also known as oligonucleotides) are known in the art and can be found described in, for example, Oligonucleotide Synthesis: A Practical Approach, Gate, ed., IRL Press, Oxford (1984); Weiler et al., Anal. Biochem. 243:218 (1996); Maskos et al., Nucleic Acids Res. 20(7):1679 (1992); Atkinson et al., Solid-Phase Synthesis of Oligodeoxyribonucleotides by the Phosphitetriester Method, in Oligonucleotide Synthesis 35 (M. J. Gait ed., 1984); Blackburn and Gait (eds.), Nucleic Acids in Chemistry and Biology, Second Edition, New York: Oxford University Press (1996), and in Ansubel et al., Current Protocols in Molecular Biology, John Wiley and Sons, Baltimore, Md. (1999).

Solid-phase synthesis methods for generating arrays of polynucleotides and other polymer sequences can be found described in, for example, Pirrung et al., U.S. Pat. No. 5,143,854 (see also PCT Application No. WO 90/15070), Fodor et al., PCT Application No. WO 92/10092; Fodor et al., Science (1991) 251:767-777, and Winkler et al., U.S. Pat. No. 6,136,269; Southern et al. PCT Application No. WO 89/10977, and Blanchard PCT Application No. WO 98/41531. Such methods include synthesis and printing of arrays using micropins, photolithography and ink jet synthesis of oligonucleotide arrays.

Methods for synthesizing large nucleic acid polymers by sequential annealing of polynucleotides can be found described in, for example, in PCT application No. WO 99/14318 to Evans and U.S. Pat. No. 6,521,427 to Evans. All of the above references are incorporated herein by reference in their entirety.

Polynucleotides can be generated on commercial nucleic acid synthesizers using phosphoramidite chemistry. The Practical Approach series has reviewed phosphoramidite and alternative synthetic strategies (Brown, T., and Dorkas, J. S. Oligonucleotides and Analogues a Practical approach, Ed. F. Eckstien, IRL Press Oxford UK (1995)).

Chemical synthesis of polynucleotides is a process in which four building blocks (base phosphoramidites) are connected as a linear polymer. In addition to the component bases, a number of reagents are required to assist in the formation of internucleotide bonds, oxidize, cap, detritylate, and deprotect. Automated synthesis can be performed on a solid support matrix that serves as a scaffold for the sequential chemical reactions; a series of valves and timers to deliver the reagents to the matrix, and finally a post-synthesis processing stream that can include purification, quantification, product QC, and lyophilization.

Some of the standard DNA bases (G, C, and A) contain primary amines that are reactive; therefore, the primary exocyclic amines can be modified with protecting groups so as to not participate in unwanted reactions during synthesis. Further, the four phosphoramidites contain a phosphorus linkage that similarly needs to be protected. Chemical groups used to protect these sensitive sites can remain intact during the DNA synthesis cycle yet can be readily removed after synthesis so that normal, unmodified DNA results. A number of different protecting strategies have been developed. For example, phosphoramidites with p-cyanoethyl protected phosphorus can be used. For the heterocyclic bases, protection of primary amines is often provided by a benzyol group for adenine and cytosine and either a dimethylformamidine or isobutyrl group for guanine. Thymine, which lacks a primary amine, does not require base protection. These protecting groups are stable under conditions used during synthesis, but are rapidly and effectively removed by treatment with ammonia.

It is also desirable to block the 5′-OH of the base-phosphoramidites so that activated monomers do not react with themselves but can only react with the 5′-OH on the growing polynucleotide chain tethered to the solid support. Current chemistry, for example, employs a dimethoxytrityl (DMT) group. After condensation, the DMT group is cleaved from the newly added DNA base by treatment with acid. Released DMT cation is orange and progress of the DNA coupling efficiency can be monitored by spectrophotometric reading at 490 nm.

The 3′ hydroxyl group of the deoxyribose sugar is derivatized with a highly reactive phosphitylating agent. The phosphate oxygen on this group is usually masked by the β-cyanoethyl moiety that can be removed by β-elimination using ammonia hydroxide treatment at elevated temperatures.

Automated synthesis can be done on solid supports, usually controlled pore glass (CPG) or polystyrene. CPG is loaded into a small column that serves as the reaction chamber. A loaded column is attached to reagent delivery lines on a DNA synthesizer and the chemical reactions proceed under computer control. Bases are added to the growing chain in a 3′ to 5′ direction (opposite to enzymatic synthesis by DNA polymerases). Although “universal” supports exist, synthesis is more often begun using CPG that is already derivatized with the first base, which is attached via an ester linkage at the 3′-hydroxyl. Synthesis starts with the first base attached to the CPG solid support and elongates in a 3′→5′ direction. CPG particles are relatively large and are porous, containing channels that greatly increase the surface to volume ratio, allowing the reaction to be done in a small reaction chamber using small volumes of reagents. The CPG is positioned in a “column” between two filter frits; with a reagent entry port on one end and an exit port (waste) on the other.

The polynucleotide synthesis cycle can proceed in four steps as described below: (1) De-blocking; (2) Activation/coupling; (3) Capping; and (4) Oxidation.

Deblocking: The synthesis cycle begins with the removal of the DMT group from the 5′ hydroxyl of the 5′-terminal base by brief exposure to dichloroacetic acid (DCA) or trichloroacetic acid (TCA) in dichloromethane (DCM). The yield of the resulting trityl cation can be measured to help monitor the efficiency of the synthetic reaction. Protection of the reactive species (primary amines and free hydroxyls), on the nucleoside building blocks insures that the exposed 5′-hydroxyl is the only reactive nucleophile capable of participating in the coupling reaction (next step).

Activation/Coupling: DNA phosphoramidites are converted to a more reactive form by treatment in tetrazole or a tetrazole derivative at the time of coupling. These processes occur through the rapid deprotonation of the phosphoramidite followed by the reversible and relatively slow formation of a phosphorotetrazolide intermediate. Coupling reactions with activated deoxyribonucleoside-phosphoramidite reagents are fast and efficient. An excess of tetrazole over the phosphoramidite can be used to ensure complete activation and an excess of phosphoramidite over reactive polynucleotide coupled to CPG. Under these types of conditions coupling efficiencies of >99% can be achieved.

Capping: Since the base-coupling reaction is not 100% efficient, a small percentage of the growing polynucleotides on CPG supports will fail to couple and result in undesired, truncated species. Unless blocked, these truncated or partial polynucleotide products can continue to function as a substrate in later cycles, extend, and result in near full-length polynucleotides with internal deletions. These truncated or partial polynucleotide products are called (n−1)-mer species. These “reaction failures” can be mostly prevented from participating in subsequent synthesis cycles by “capping”, which involves acetylation of the free 5′-OH with acetic anhydride.

Oxidation: At this point, the DNA bases are connected by a potentially unstable trivalent phosphite triester. This species is converted to the stable pentavalent phosphotriester linkage by oxidation. Treatment of the reaction product with dilute iodine in water/pyridine/tetrahydrofuran forms an iodine-phosphorous adduct that is hydrolyzed to yield pentavalent phosphorous. The oxidation step completes one cycle of polynucleotide synthesis; subsequent cycles begin with the removal of the 5′-DMT from the newly added 5′-base.

Cleavage and Deprotection: After synthesis is complete, the polynucleotide can be cleaved from the solid support with concentrated ammonium hydroxide at room temperature. Continued incubation in ammonia at elevated temperature will deprotect the phosphorus via S-elimination of the cyanoethyl group and also removes the protecting groups from the heterocyclic bases.

Post Synthesis Handling: During synthesis, both full-length polynucleotides and truncation products or partial polynucleotide products remain attached to the CPG support. Following synthesis, the species are similarly cleaved and recovered so that the final reaction product is a heterogeneous mixture of wanted and unwanted species. Impurities accumulate to a greater degree as polynucleotide length increases. Furthermore, cleaved protecting groups are also present. At this point, polynucleotides are traditionally “desalted”, a process in which small molecule impurities (protecting groups and short truncation products) are removed using gel filtration or organic solid-phase extraction (SPE) methods.

Use of desalted polynucleotides with no additional purification can be appropriate when using short primers in simple applications, such as routine PCR or DNA sequencing. However, n−1 and other truncation or partial polynucleotide species can lead to deletion mutants if used in cloning, site-directed mutagensis or gene assembly applications. Purification by PAGE or HPLC can be used to remove truncated or partial polynucleotide species.

Polynucleotide synthesis efficiency is typically about 98-99% for each cycle of chemistry, so for each cycle about 1-2% of the reaction products will be 1 base shorter than expected. Some truncated species fail “capping” and continue to participate in additional cycles of DNA synthesis. For a 60-mer polynucleotide, less than 50% of the final product will be the desired full-length molecules. The final synthesis product will include a mixed population of (n−1)-mer and (n−2)-mer (etc.) molecules which represent a heterogeneous collection of sequences, effectively a pool of deletion mutants at every possible position.

Synthesis scale refers to the amount of starting material while synthesis yield refers to the amount of final product recovered after the synthesis and purification steps have been completed. In polynucleotide synthesis, the 3′ terminal base is attached to a solid support at the scale ordered by the customer. Bases are added one at a time in the 3′ to 5′ direction. Ideally, each added base would couple with 100% efficiency, resulting in 100% yields. In reality, coupling efficiency is somewhat less than 100%, and this small decrease can result in a substantial decrease in yield of the final oligonucleotide (since the effects of coupling efficiency will be additive). Moreover, coupling efficiency can vary for each base added, therefore the sequence itself can contribute to wide variations in yields. For a 250-nmole-scale reaction, the final yield after deprotection and purification can range from 10 to 100 nmoles. Some sequences tend to produce higher yields than others, and this trend is usually reproducible. The yield for the synthesis of one 20-base sequence can be twice that obtained for a different 20-base sequence, even if the two sequences are run on the same day, on the same machine, using the same reagents. Some variability in yields can also be derived from the individual machine used.

Theoretical yield for a given synthesis is (E_{ff})ⁿ⁻¹ with E_{ff} representing coupling efficiency and ‘n’ representing the number of bases in the polynucleotide. If the coupling efficiency is 99% (E_{ff}=0.99), the fraction of full-length product present after synthesis will be approximately (0.99)¹⁹ or 83% for a 20-mer; (0.99)⁴⁹ or 61% for a 50-mer; and (0.99)⁷⁴ or 48% for a 75-mer. A small decrease in coupling efficiency will result in a substantial decrease in expected yield. For example, if coupling efficiency is 99%, the yield for a 100-mer is (0.99)⁹⁹ or 37%, but if the coupling efficiency drops to 98%, yield falls to (0.98)⁹⁹ or 13%.

However, coupling efficiency varies with each base added. Coupling efficiency is lower for the first five to six bases, presumably because of steric hindrance near the surface of the solid support. Coupling efficiency then increases to an optimum of about 99%, as is characteristic for the addition of the twentieth base, and then once again, falls to suboptimal levels as length increases. Since coupling efficiency actually decreases as the polynucleotide becomes very long, yields on 100-mers can often be less than 10%. Product is also lost during any purification process, if done, which further decreases yields.

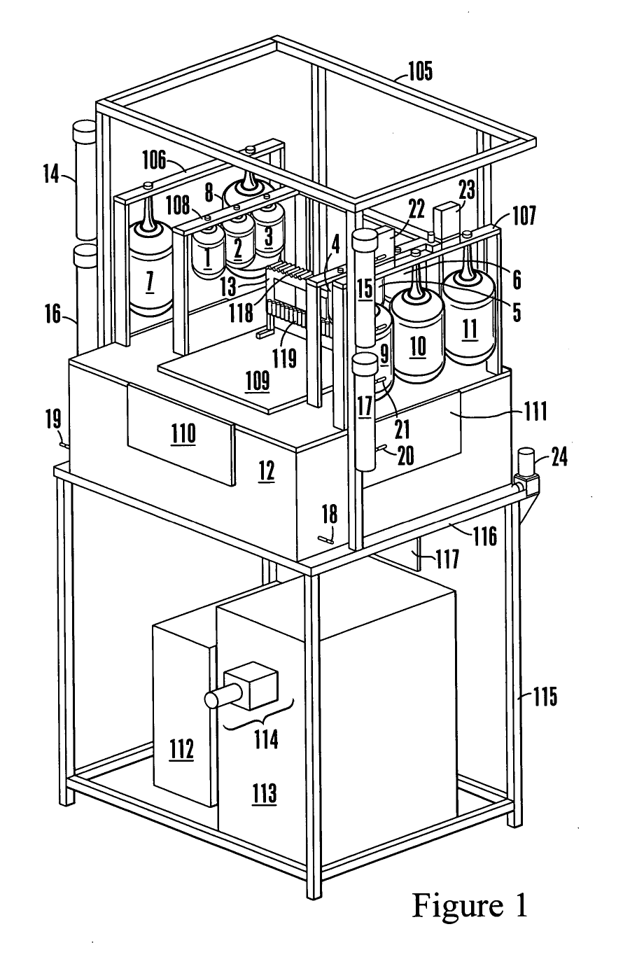

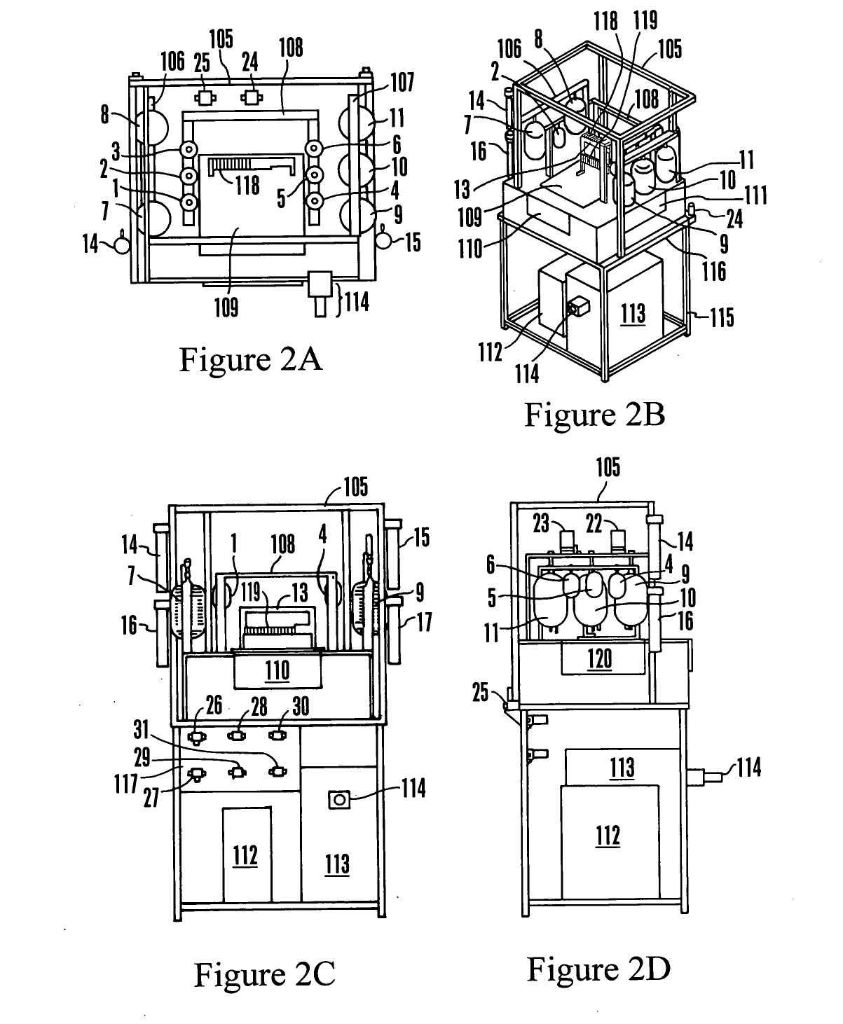

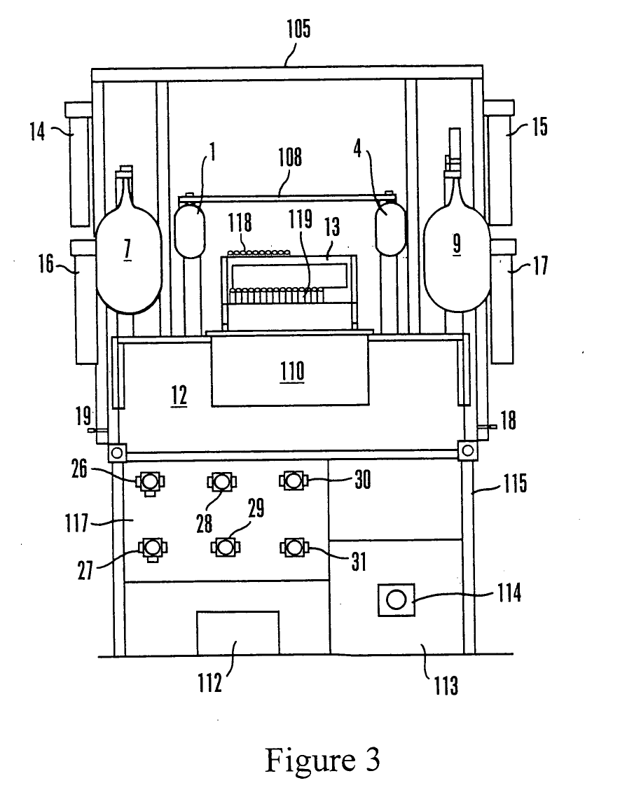

The invention provides an apparatus for maintaining a closed continuous anhydrous system for automated polynucleotide synthesis having: a) a plurality of moisture-resistant reagent containers; b) a dry box capable of forming a seal over a synthesis platform of an automated polynucleotide synthesizer; c) moisture-resistant tubing connecting the reagent containers to the dry box; d) a reagent gas feed connecting the reagent containers to a gas, where the gas pressurizes the reagent containers; and e) a digital gas regulator connected to the reagent gas feed, where the gas regulator maintains constant pressure in the reagent containers. The closed continuous anhydrous system can regulate moisture content in the system. An example of an apparatus of the invention is shown in FIG. 1 with various views and close-up diagrams of an apparatus shown in FIGS. 2-8.

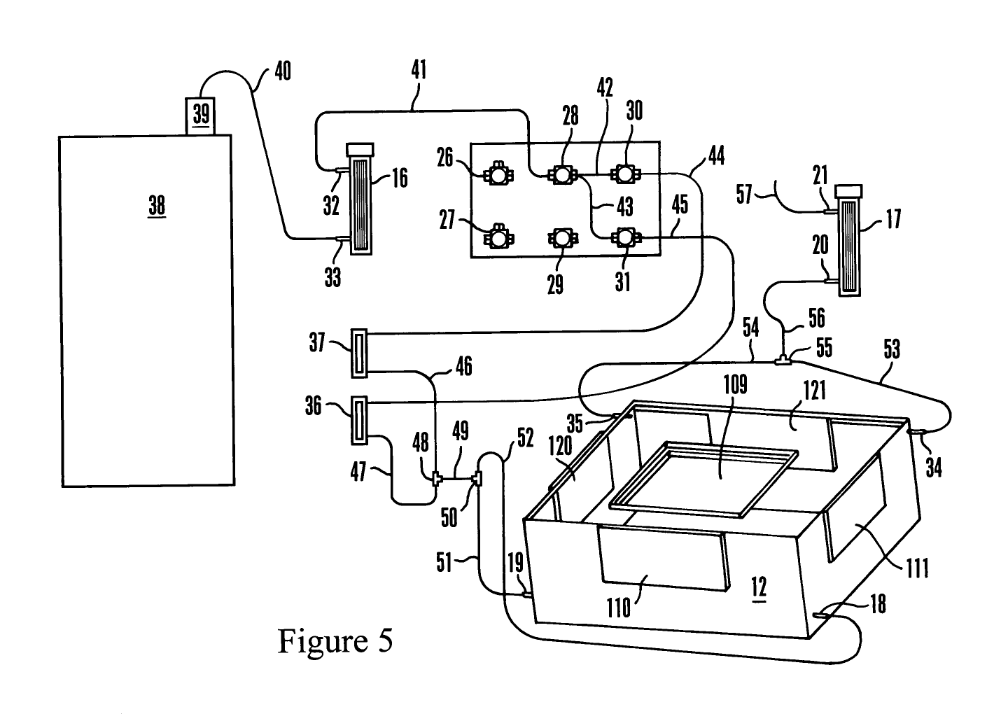

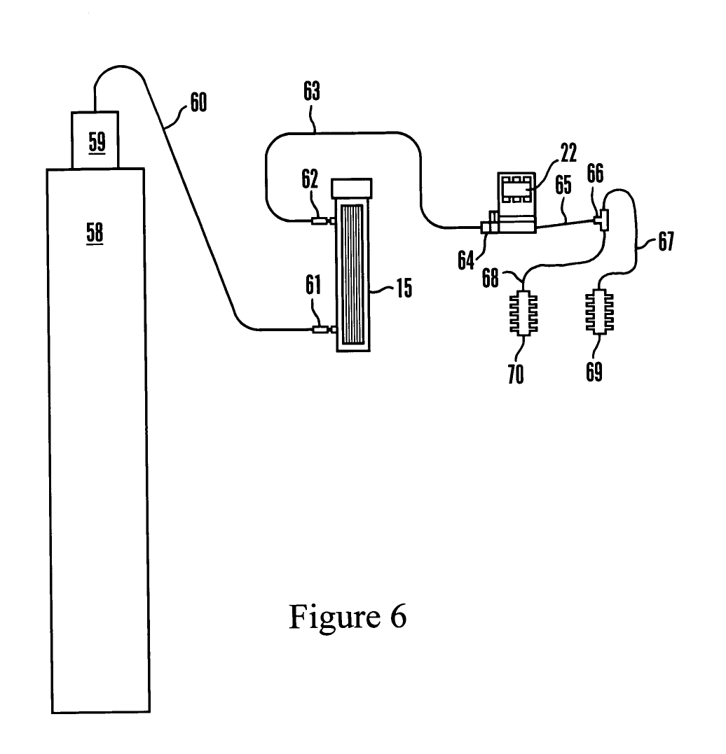

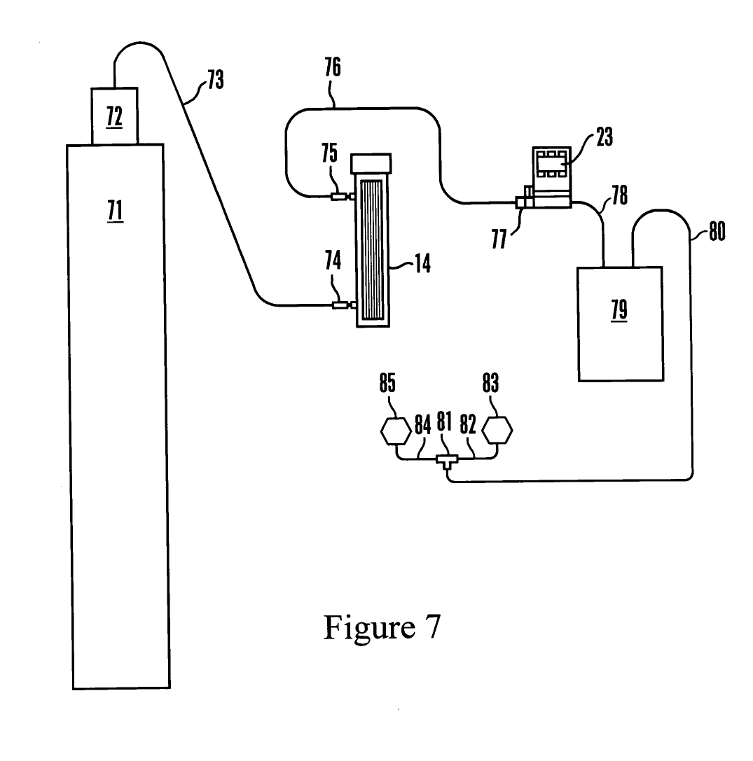

As shown in FIG. 1, an apparatus of the invention contains a plurality of reagent containers. In FIG. 1, reagent containers that hold nucleotide reagents are labeled 1-6. Reagent containers that contain synthesis solutions such as deblock, oxidizer, activator and capping reagents are labeled 7-11. The apparatus also contains a dry box (12) which is capable of forming a seal over a synthesis platform of an automated polynucleotide synthesizer (inside dry box, not shown). Tubing (not shown) connects the reagent containers to the dry box (12) through individual solenoid valves (118, 119). Additional tubing, collectively called the reagent gas feeds (for example, 60, 63, 65, 67, 68, 73, 76, 78) connects the reagent containers to a gas cylinder (shown in FIGS. 6 and 7). Digital gas regulators (22, 23, see FIGS. 6 and 7) are connected to the reagent gas feeds. In addition, two flow through gas dryers (16, 17, see FIG. 5) are connected to the dry box (12). Also two flow trough gas dryers are located in the reagent gas feed used to pressurized the nucleotide reagent containers (15, see FIG. 6) and gas feed used to pressurize the wash solution containers (14, see FIG. 7).

As shown in FIG. 1, an apparatus of the invention contains a plurality of reagent containers. Reagent containers can hold any reagent used at any point in the synthesis reaction. For example, a reagent container can hold a nucleotide reagent (1-6), another synthesis solution such as deblock, oxidizer, activator or capping reagents (7-11) or a wash solution such as acetonitrile. Four of the reagent containers that hold nucleotide reagents can be used to hold nucleotide base reagents such as adenine, thymine, cytosine, and guanine. A fifth container can hold the final phosphate phosphoramidite base and a sixth container can be used for a combined nucleotide base reagent, if required. In one embodiment, the reagent containers are nucleotide solution containers or wash solution containers. In another embodiment, the apparatus contains a wash solution container and one or more nucleotide solution containers.

The reagent containers are capable of holding liquid reagents. In one embodiment, the reagent containers are moisture-resistant. Moisture-resistant containers do not allow moisture from the outside environment to penetrate to the inside of the container. A moisture-resistant container is made of or coated with a moisture-resistant material such as stainless steel, glass or a plastic. Reagent containers are also resistant to the material that they hold, for example, a reagent container that holds a solvent such as acetonitrile is a solvent-resistant container.

To assure that the reagents being used are moisture free, the reagent containers, for example, glass bottles, can be cleaned and oven dried before the reagents are mixed. The bottles are filled within a dry box and molecular sieves are added and allowed to settle for 24 hours before the reagent is used. In addition, a Teflon filter is added to the intake line that is inserted into the reagent containers. This decreases the amount of fines or other small particles from sieves introduced into the intake lines and introduced into the synthesis plate.

Glassware can be cleaned, for example, using the following protocol. Amber coated bottles of any size, for example, 4 L, 950 ml, and 450 ml, for holding liquids and amidites can be cleaned as follows. Rinse bottle with ACS reagent grade acetonitrile four times, with ACS reagent grade acetone twice and then with ACS reagent grade methanol twice. Wipe off outside of bottle until no streaks are visible. Let drain upside down for 2-3 minutes. Place upside down in 65° C. or hotter oven (resting on paper towels) for 24 hours.

Test tubes or custom glass ware, for example, for holding phosphate phosphoramidite or specialty amidites, can be cleaned as follows: Rinse test tube brush in hot water. Scrub test tube with Micron-90. Rinse test tube brush before replacing in Micron-90 solution. Rinse glassware in hot water then in deionized (dI) water. Rinse glassware with ACS reagent grade acetonitrile four times, with ACS reagent grade acetone twice and then with ACS reagent grade methanol twice. Wipe off outside. Place upside down in 65° C. or hotter oven (resting on paper towels) for 24 hours.

Reagents used in the synthesis reaction are commercially available, for example, from Cruachem (Dulles, Va.), Beckmann Instruments (Fullerton, Calif.), ABI (Foster City, Calif.), and Glen Research (Sterling, Va.). The phosphoramidites are typically delivered in powdered form in 50-gram quantities and can be diluted with anhydrous acetonitrile (0.0002% H₂O; >10 ppm H₂O) directly into, for example, 950-ml reagent bottles in a separate glove box filled with dry argon or nitrogen. This provides sufficient quantities of reagents for 10 two-plate runs of 20-mers.

Amidite bases can be prepared as follows. Work can be done in an anhydrous glove box located in a hood. First, assemble necessary reagents: Amidites (A, G, T, C) from, for example, Annovis (950 ml bottles) and dry Acetonitrile (950 ml bottles) from, for example, EM Science. Place these items in the dry box and close. Turn on nitrogen gas and “fast purge” until the humidity monitor reaches 0-2% relative humidity. Then close valve at top and continue nitrogen purge at lower flow rate with 10 psi pressure inside anhydrous glove box.

The working concentration is 1 g dry phosphoramide/16-19 ml dry acetonitrile solvent—dry acetonitrile is poured to the neck of the 950 ml bottle containing 50-60 grams dry A, G, C, or T phosphoramidite powder. Shake the bottle vigorously to suspend phosphoramidite powder into solution. Wait until the amidite is completely dissolved and then add about 50 grams zeolyte to each bottle and cap. Date the bottle and mark the lot numbers. Remove from the anhydrous glove box and place dry amidite solution reagent bottles on synthesizer. A, T, G and C can be used for about 2 weeks after suspension of the dry A, T, G, C amidite powders into dry acetonitrile solvent.

Phosphate phosphoramidite can be prepared as follows. Work can be done in an anhydrous glove box located in a hood. This amidite can be prepared after the run is complete. First, remove 5′-CE phosphorylating phosphoramidite (either 0.5 g or 1.09 bottles from Cruachem, DMT off) from the −80 degrees C. freezer and place in anhydrous glove box. Also place dry acetonitrile, a chemically resistant syringe, a 21 gauge needle, a clean, dry amber coated custom glassware (50 or 15 mL) and a cap in glove box. Turn on argon or nitrogen and “fast purge” until humidity monitor reads 0-2% relative humidity. Close valve and reduce anhydrous gas purge. Open packages. The correct concentration is 0.5 g dry phosphoramidite/8 ml dry acetonitrile solvent. Calculate how much of this solution is needed —100 μl per well twice for double coupling. For a 96 well plate, this is 19.2 ml (add 22 ml to be safe). Use a syringe (10-20 cc and 21 gauge needle) to transfer dry acetonitrile solvent to amidites within their own packaging. Let amidite dissolve at room temperature for 10 minutes. Purge the custom conical 50 ml amber glass with dry nitrogen. Transfer solution to the clean, dry glassware by removing the septa cap from the 5′ solution in order to get every drop. Cap. Remove the acetonitrile wash bottle or oven dried empty bottle in the d5 position. Place the custom glassware in the d5 position. Keep the bottle uncapped for as little time as necessary. Prime the line with 1-2 mls of dry phosphate phosphoramidite. Do not mix with old phosphorylating reagents. The 5′ phosphate phosphoramidite reagent is on the synthesizer for 1 hour or less.

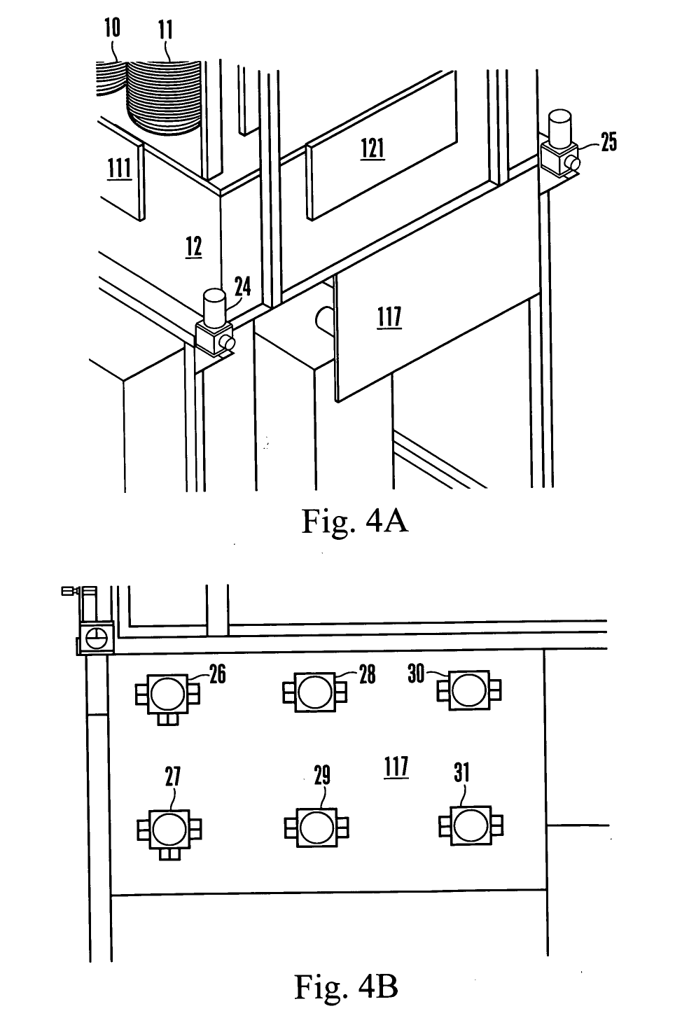

As shown in FIG. 1, an apparatus of the invention contains a dry box (12). The dry box is a hood that can be placed over a synthesis platform of an automated polynucleotide synthesizer. The synthesis platform then becomes the bottom of the dry box. When the dry box is sealed over the synthesis platform it can become part of a closed continuous system around the synthesis platform. The dry box can be constructed of several materials, for example, a moisture- and solvent-resistant material such as Pyrex glass, stainless steel, polypropylene, or Teflon can be used. In one embodiment, the dry box is made of a moisture-resistant material and sealed over a synthesis platform so as to provide a closed continuous anhydrous system for polynucleotide synthesis. The dry box shown in FIG. 1 contains glass viewing windows (109, 110, 111 shown in FIG. 1, 120 in FIG. 2D, and 121 in FIG. 4A) that can be used to see the interior of the dry box which contains the synthesis platform.

The apparatus of the invention contains several seals, for example, a seal between the dry box and synthesis platform and seals between connectors and containers. A seal is intended to mean a closure forming an airtight connection. A seal can be made of any material capable of making an airtight connection, for example, with glass, plastic or metal. Additionally, seals can be made of solvent-resistant material. Sealing materials include, for example, rubber, TYGON, or silicone. In one embodiment, connections in the apparatus of the invention are sealed to exclude moisture entry. In another embodiment, the connections are sealed with silicone caulk. In a further embodiment, the connection are double-sealed.

Seals used in the apparatus should be of sufficient strength to maintain an airtight connection. The strength of a seal can be measured, for example, by its ability to maintain a vacuum or pressure of a certain strength. The sealed connection of an apparatus of the invention can maintain a pressure of greater than 100 psi, greater than 75 psi, greater than 50 psi, or greater than 25 psi. In one embodiment, the sealed connections of an apparatus of the invention can maintain a pressure of greater than 25 psi.

Seams of the dry box can be double sealed, inside and out, and the gaskets on the access doors are reinforced with silicon sealer. In addition, the cable couplings are sealed and the open tube couplings that are used to feed the injection lines through are sealed using silicone rubber sealant.

An apparatus of the invention contains a humidity meter inside the dry box. For example, the humidity meter can be a digital humidity meter. The meter can allow the internal dry box humidity to be continually monitored by the system in real time. This data can then be fed into a computer, manually or automatically, and used to determine when synthesis should begin as opposed to waiting a predetermined period of time before beginning synthesis. For example, synthesis can be programmed to begin when the humidity within the dry box is less than or equal to 1% humidity. In addition, the system can alert the operator if the humidity is above a specific amount and suspend the synthesis reaction if necessary.

The efficiency of the synthesis reaction can be improved by the addition of a humidity meter since the reaction can not begin or can not proceed if the humidity content of the synthesis dry box is too high. In addition, beginning the synthesis reaction based on the humidity level instead of a set period of time can speed up the synthesis reaction if the time needed to reduce the humidity to an acceptable level is less than the set period of time. Humidity meters are commercially available, for example, from Dickinson such as the Dickinson Model TP120 SN 02221347.

As shown in FIG. 1, an apparatus of the invention contains reagent containers (1-11), a dry box (12), and a chemical injection line device (13, 118, 119). Tubing which connects the various components of the apparatus are shown in FIGS. 5-8. The tubing can be, for example, moisture- and solvent-resistant tubing. Several types of moisture- and solvent-resistant tubing are known in the art and commercially available, such as plastic and TYGON, Teflon, and polypropylene tubing. For example, the tubing used in the apparatus can be Teflon tubing.

Tubing can be connected to reagent containers in a variety of ways. For example, tubing can be removably connected to the other components of the apparatus such as the reagent containers. This allows for rapid and convenient adjustment or replacement of the tubing and changing of the containers. In one embodiment a removable connection can be achieved by stretching the tubing over the outer surface of opening such as an inlet or outlet port of the container. The tubing stretched over the outer surface of the inlet or outlet port can be held in place by a clasp such as an elastic ring or a metal clasp. Also, for example, the tubing can be held in place by an outer sheath that wraps around an outer surface of an opening such as an inlet or outlet port on one end and an outer surface of an inlet or outlet port on the other end to form an airtight closure. A convenient outer sheath can be a short section of tubing including, for example, TYGON tubing. Also, for example, Swaglok Parker pressure pipe fittings, polypropylene and stainless steel fittings can be used to connect tubing to various containers.

As shown in FIG. 6, an apparatus of the invention contains reagent gas feeds or lines (for example, 60, 63, 65, 67, 68) connecting the reagent containers to a gas (58) that pressurizes the reagent containers. In one embodiment, the reagent gas feed is made of moisture- and solvent-resistant tubing. Because a gas feed carries pressurized gas, tubing and seals of appropriate strength and composition are used. For example, the gas feeds can be Teflon tubing that is connected at one end to a gas cylinder using Swaglok pressure pipe fitting and at the other end to a reagent container or containers using Swaglok pressure pipe fittings. A reagent gas feed can connect a reagent such as a nucleotide solution to a gas cylinder, for example, a helium gas cylinder. Helium can be used to pressurize the reagent bottles which can prevent bubbles in the delivery lines. In addition, a reagent gas feed (for example, 73, 76, 78) can connect a reagent such as a wash solution, for example, acetonitrile, to a gas cylinder (71) (see FIG. 7).

Several types of gases can be used in an apparatus of the invention. The gases used in an apparatus of the invention can be stable or inert gases that contain little reactivity on their own. For example, noble gases such as helium, neon, argon, krypton, xenon, and radon are inert gases that can be used in the apparatus. In addition, a gas such as nitrogen can be used in an apparatus of the invention as an inert gas. In one embodiment, the gas used in an apparatus of the invention is nitrogen, argon, or helium. In another embodiment, helium is used to pressurize reagent containers and nitrogen is used in the dry box. The nitrogen gas can be derived, for example, from a liquid nitrogen (N₂) boil off dewar. An advantage to using nitrogen is that it is an inexpensive gas.

As shown in FIG. 1, an apparatus of the invention contains a digital gas regulator (see 22, 23) where the gas regulator maintains constant pressure in the reagent containers. In one embodiment, the gas regulator is a digital gas regulator. A gas regulator can monitor the level of gas pressure accurately in real time and is capable of making adjustments to the level of gas in order to keep gas pressure constant. A constant level of gas pressure is a level of pressure that may fluctuate slightly around a desired value. For example, as the volume of a reagent drops, the pressure in the reagent container changes. This change is rapidly detected by the gas regulator and a signal is sent that results in regulation of the gas pressure back to the desired level. The gas regulator can quickly react to small changes in gas pressure such that the level of gas pressure is essentially constant, although small changes in gas pressure can be experienced for short periods of time. If for some reason the pressure in the system drops below a specific amount, the system can alert the operator and suspend the synthesis reaction if necessary.

In one embodiment, an apparatus of the invention contains a flow through gas dryer (for example, 14, 15) connected to tubing that connects a reagent container (1-11) to a gas supply (for example, 58, 71). For example, an apparatus of the invention can contain a flow through gas dryer (14, 15) connected to a reagent gas feed (for example, 60, 63, 65, 67, 68, 73, 76, 78). In a further embodiment, an apparatus of the invention contains at least one flow through gas dryer (16) connected to tubing (for example 40, 41) that connects a gas cylinder (38) to a dry box (12) (see FIG. 5). As shown in FIG. 5, a flow through gas dryer (17) connected through tubing to a dry box (12) outlet can be vented to the atmosphere. In a still further embodiment, an apparatus of the invention contains a flow through gas dryer connected to the dry box gas outplet port, a flow through gas dryer connected to the reagent gas feed used to pressurize nucleotide solution containers, and a flow through gas dryer connected to the reagent gas feed used to pressurize the acetonitrile wash solution container (also known as a dewar).

The flow through gas dryers connected to the dry box gas inlet and outlet ports can be used to help ensure that the gas being introduced from the liquid nitrogen dewar into the dry box is pre-dried and that little to no moisture is introduced via back flow from the dry box exhaust. The flow through gas dryers connected to the reagent gas feeds help to ensure that moisture is not introduced into the reagents or wash chemicals.

The flow through gas dryers can contain a dessicant material. In addition, dessicant material can be put inside the dry box or in any location to reduce moisture content. A dessicant is a moisture absorbing material. Many dessicants are known in the art and commercially available, for example, clay based substances and zeolites. Commercially available dessicants include, for example, Drierite and Siliporite NK10F. In one embodiment, the dessicant material used in an apparatus of the invention is phosphorous pentoxide and sodium hydroxide. In another embodiment, the dessicant material used in an apparatus of the invention is DRIERITE and 5A Molecular Sieve.

A flow through gas dryer can be, for example, a DRIERITE Gas Purifier which is filled with indicating DRIERITE and 5A Molecular Sieves for the removal of moisture, impurities and particulates from gas lines. Such a gas purifier can be attached using compression type tube fittings. Color change of DRIERITE from blue to pink indicates exhaustion of drying capacity. DRIERITE can be replaced or regenerated by known procedures. The 5A Molecular Sieves remove impurities that have an effective molecular diameter of less than 5 angstroms. The DRIERITE Gas Purifier is commercially available. It has a column made of molded polycarbonate and a polycarbonate cap fitted with an o-ring gasket. The DRIERITE and molecular sieves are held in place between felt filters. The bed supports and coil springs are stainless steel and the outlet frit is 40 micron. The dimensions of the column are 2⅝ inches by 11⅜ inches. The connections are 1/8 inch stainless steel male tube fittings. The recommended maximum working pressure is 100 psig and water capacity is 25 grams. The recommended flow rate is up to 300 liter per hour for maximum efficiency.

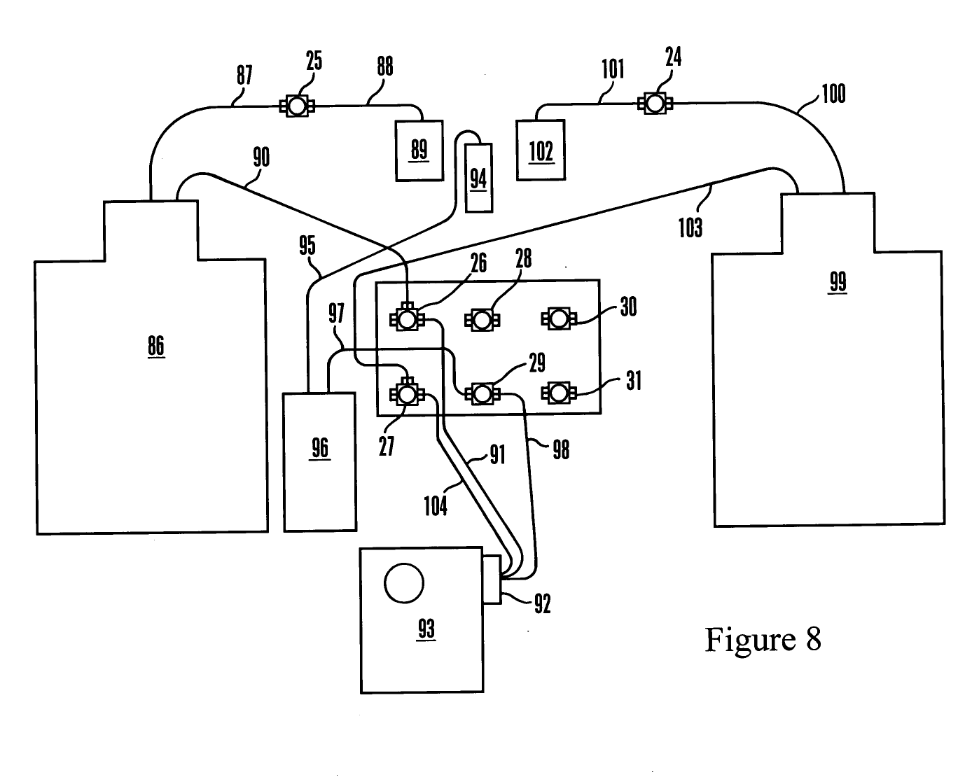

An apparatus of the invention can contain at least one in-line solenoid value (24, 25) between the synthesis plate vacuum chuck and the waste container. These normally closed solenoids can be activated by the main vacuum system and act to isolate the waste container from the synthesis filter plate after the plate is evacuated (see FIG. 8). This can prevent the waste container from equalizing and allow the container to be kept under continuous negative pressure (vacuum). The resulting effect is that the system can vacuum out the synthesis plate immediately, rather than first needing to pump down the waste container. In another embodiment, an apparatus of the invention can have three way vacuum inlet solenoid valves (26, 27) that are re-routed and shunted to prevent equalization (see FIG. 8). A high strength vacuum system, such as a Welch self-cleaning Teflon drg Vacuum System Model 2025 can be used in an apparatus of the invention.

The chucks used to mount the synthesis plate can be modified to have a deeper collection basin than in a standard synthesizer. For example, the chucks can be modified to have an 8 mm deeper collection basin. This modification is useful so that if reagents leak through the filter plate during a reaction step, the reagent will not fill the basin and cross contaminate different synthesis microwells in the filter synthesis plate.

An apparatus of the invention can be used in conjunction with a polynucleotide synthesizer device in order to increase the quality of the resulting polynucleotide products. Therefore, the invention also provides an apparatus for maintaining a closed continuous anhydrous system for automated polynucleotide synthesis, containing: a) a plurality of moisture-resistant reagent containers; b) a dry box capable of forming a seal over a synthesis platform of an automated polynucleotide synthesizer; c) moisture-resistant tubing connecting the reagent containers to the dry box; d) a reagent gas feed connecting the reagent containers to a gas, where the gas pressurizes the reagent containers; e) a digital gas regulator connected to the reagent gas feed, where the gas regulator maintains constant pressure in the reagent containers; and f) a polynucleotide synthesizer device.

As described further above, the connections in the above described apparatus can be sealed to exclude moisture entry, for example, using silicone caulk. Also the sealed connections can maintain a pressure of greater than 100 psi strength. Also as described above, the reagent containers can be nucleotide solution containers or waste solution containers, and in one embodiment, the reagent containers are a wash solution container and one or more nucleotide solution containers. The apparatus can further contain at least one flow through gas dryer connected to the tubing that pressurizes the reagent containers delivering dry reagents to the dry box, or connected to a reagent gas feed. Further, the apparatus can contain a humidity meter.

Several polynucleotide synthesizer devices which are known in the art, both custom-made and commercially available, can be incorporated into an apparatus of the invention. In one embodiment, an apparatus of the invention contains a polynucleotide synthesizer such as described in Rayner et al. (Genome Research 8:741-747 (1998)), which can be attached to, or a component of, an apparatus of the invention.

The polynucleotide synthesizer can synthesize two standard 96-well plates of polynucleotides in a single run using standard phosphoramidite chemistry. The machine is capable of making a combination of standard, degenerate, or modified polynucleotides in a single plate. The run time can be about 17 hr or less for two plates of 20-mers and a reaction scale of 40 nM. The reaction vessel can be a standard polypropylene 96-well plate with a hole drilled in the bottom of each well. The two plates are placed in separate vacuum chucks and mounted on an xy table. Each well in turn is positioned under the appropriate reagent injection line and the reagent is injected by switching a dedicated valve. Machine operation is controlled by a computer, which also guides the user through the startup and shutdown procedures, provides a continuous update on the status of the run, and facilitates a number of service procedures that can be carried out periodically.

In addition to the polynucleotide synthesizer described by Rayner et al. supra, there are other high-throughput polynucleotide synthesizers available for the rapid synthesis of multiple polynucleotides. For example, a polynucleotide synthesizer designed and built by the Human Genome Center at Lawrence Livermore National Lab uses a multichannel format (Sindelar and Jaklevic, Nucleic Acids Res. 23:982-987 (1995)). This system also uses phosphoramidite chemistry, but is limited to 12 polynucleotides each run. AMOS, the polynucleotide synthesizer designed and built at the Genome Center at Stanford University uses the same chemistry and synthesizes directly into a 96-well format on a reaction scale similar to the MerMade synthesizer (Lashkari et al., Proc. Natl. Acad. Sci. USA 92:7912-7915 (1995)).

A polynucloetide synthesizer can have a footprint of about 3×3 feet and stand about 6 ft high. The synthesis reagents can be stored at the top of the machine in standard pressurized media bottles and are transferred by Teflon lines to the synthesis chamber located at the center portion of the machine. The electronics and computer controlling the machine can be located in a separate cart that can be placed either inside or outside the main frame as convenience dictates. Two argon tanks (to provide bottle pressure and an inert synthesis environment) can be strapped to the side of the frame. The machine can be operated by a Macintosh Quadra 950 running a control program written in LabView (National Instruments, Austin, Tex.). The program guides the operator through the startup and shutdown procedures and controls the synthesis process while providing the user with a continuously updated system status.

The synthesis chamber can consist of three components: the inner chamber, the outer chamber, and the xy table. The two 96-well plates are placed inside two separate vacuum chucks, which are then placed into the inner chamber, the inner chamber is sealed and mounted on the xy table. This in turn is contained within a larger outer chamber of sufficient size to accommodate the full motion of the xy table. The injection head is mounted on the top of the outer chamber, and the xy table, which is under the control of the computer, moves the plates around underneath the chemical injection head. The chemistry is particularly sensitive to the presence of water vapor and air (Gait “Oligonucleotide Synthesis: A practical-approach” Oxford University Press, New York, N.Y., 1984). The combination of the two chambers is designed to exclude these contaminants from the reactions. In addition, argon is pumped continuously into the inner chamber, and a small gap between the top of the walls of the inner chamber and the roof of the outer chamber for a constant flow of argon to minimize any contamination of the phosphoramidite and tetrazole lines by vapors from the deblocking and oxidizing lines. In contrast to an oligonucleotide synthesizer which uses a combination of two chambers to reduce water vapor and air from the reactions, the claimed apparatus contains one continuous anhydrous dry box reaction chamber.

The two synthesis plates can be individually mounted inside two vacuum chucks to allow drainage of the reagent chemicals after each stage. The vacuum chuck consists of two parts that bolt together around the plate. The lower half of the chuck contains a gasket to provide a seal between the plate and the chuck, and a drain line that is connected to a vacuum. The plates can be mounted in the vacuum chucks before loading through a sealable access door in the top of the outer chamber.

The reagents can be introduced into the wells, for example, via the chemical injection head. The chemical injection head can be located in the center of the access door (which also facilitates cleaning the head before each run). The chemical injection head can consist of 15 lead-throughs to carry the reagents inside the chamber. Six of the injection heads are in pairs. Four of these pairs are for the simultaneous injection of a phosphoramidite plus activator to minimize table movement for this stage. The fifth is for injection of the two chemicals for the capping stage. The final injection pair is for either modified or degenerate bases. The reagents can be delivered from the bottles to the dc solenoid valves and from the valves to the lead-throughs by 1/16-inch diameter Teflon tubing. Silcone sealant can be used to produce a seal through which the tubing enters the lead-through. The valves can be controlled individually by solid-state relays that are switched by the software. The smallest injection volumes obtainable with these valves is <20 μl. However, to ensure proper mixing of the reagents in the wells, the injection volume should be at least 60 μl.

The electronics of a synthesizer can have three principal components: the motor amplifier box, the relay box, and the power supply box. The xy table motors can be controlled by a NuLogic0L controller card (NuLogic, Needham, Mass.) which sends the controlling signals from the software to the motor amplifier box. The motor amplifier box in turn sends the necessary voltages to the motors and returns motion limit and home signals back through the card to the control software. The valves can be controlled by a National Instruments NB-DIO-96 card. Signals are sent from the card to three banks of relay cards (each card contains eight relays). Two cards control the DC valves for reagent injection; the third card controls the AC valves which are used for argon and vacuum systems. The AC and DC voltage sources for the motors and valves are provided by the voltage supply box.

A synthesizer can be controlled by a Macintosh Quadra 950 computer running LabView-3.1.1 (National Instruments, Austin, Tex.). The software controls the machine operation. The startup procedure is performed by following a series of dialog boxes that prompt the operator through the necessary steps. Once the machine has been set up for a run and the synthesis procedure has been started no further user intervention is required. The software handles the table motion and valve operations, provides a continuous update on the status of the synthesis process, and performs the required shutdown steps once the synthesis is complete. In addition, there are a series of options to allow the user to perform a variety of service and maintenance procedures (such as calibration of injection volumes and resetting plate offsets and well positions).

The solenoid valves on the synthesizer as part of an apparatus of the invention can be calibrated using the following procedure.

On the computer software select “Calibrate Valves” and then “Load Run Profile.” The door of the main chamber should be upright. Starting on the left side, click on the line you wish to calibrate. Settings will come up in (1) This is the current injection time and (2) This is the current injection volume/base. Type settings into (3) Enter a new injection time here and (4) Enter a new injection volume here respectively. Under (5) How many injections do you want to perform, the following settings can be used, for example: 5 for 120 μL, 6 for 100 μL, 2 for 600 μL, etc. Select “Inject” to clear lines. Once lines are shooting clean and straight, place a clean eppindorf tube underneath the chosen line and click “Inject” again. To determine the amount actually being delivered at a given injection time use the following formula: (volume in eppi)/(# of injections).

Make changes to the injection times as necessary so that the volumes are as follows, for example: dt, dA, dG, dC, d5, act T, act A, act G, act C, act 5, cap B, deblock: 100 μL; Wash: 650 μL; Oxidizer: 80 μL; cap A: 120 μL. Once you have made a change that you want to keep, select “Save Replace.” Do the deblock last. Select “Exit” and then “Edit Run Profile.” The following wait times can be used, for example: Deblock Step: 50 sec; Coupling Steps—A, T, G, C and 5: 270 sec; Capping Step: 100 sec; Oxidize Step: 70 sec. The following purge times can be used, for example: Purge 1: 1800 sec; Drain: 2 sec; Purge 2: 1800 sec. (1 and 2 refer to each chamber purge). The following vacuum times can be used, for example: Drain 1: 15 sec; Equalize 1: 2 sec; Drain 2: 15 sec; Equalize 2: 2 sec. (1 and 2 refer to the plates).

Parameters necessary for the synthesis run can be stored in a group of simple text files that are accessed by the control software. These files contain the sequence for each polynucleotide as well as information about the injection volumes, the wait times for each stage in the synthesis cycle, the number of wash cycles after each stage, as well as the plate and well offsets and motor speed/acceleration for the xy table. These can be edited for each plate to allow different concentrations and yields for the plates.

The synthesis process is carried out from the 3′ to 5′ end. The reactions are initialized by using a Controlled Pore Glass support (CPG) (Prime Synthesis or Glen Research), with the first base already attached. Subsequent bases are then attached to this support. There are two options available for the reaction plate. A cost effective method is to modify a standard 96-well plate (National Lab Net, Woodbridge, N.J.) which drills a 1/64-inch hole in the bottom of each of the wells. A support for the CPGs is provided by cutting a circular glass fiber frit ˜3 mm in diameter (Scienceware, Pequannoq, N.J.) and placing it at the bottom of each of the wells. An alternative is to use a filter plate with frits already loaded in the wells (Orochem DNA synthesis filter plate). This arrangement is slightly more expensive, but the cost is offset by the time saving in plate preparation. In both arrangements the combination of the support and hole size are sufficient to ensure the reagents remain in the wells until a vacuum is applied to the underside of the plate.

The reaction parameters can be adjusted to satisfactory operating requirements by evaluating polynucleotide quality using a combination of capillary electrophoresis (CE) high performance liquid chromatography (HPLC) and mass spectrometry. The CE and HPLC traces provide information about the % purity of N, whereas the HPLC traces can be used to quantify the amounts of residual chemicals left after the synthesis process is complete. Once the sequence data have been read in, there is an initial 30-minute purge step to fill the reaction chamber with nitrogen and expel the air. The computer then moves the xy table to align each well in turn with the chemical injection line appropriate to the current step in the synthesis process and operates the corresponding valve or valves. Once the injections for that step are finished, there is a wait time of 50-270 seconds to allow the reaction to complete. Reagents are removed from the plate by application of a vacuum to the chuck. After each stage the wells are washed with ˜600 μl of acetonitrile one or two times (depending on the synthesis step) to ensure the unused reagents are removed prior to the next stage of synthesis.

A protocol for loading the filter plate is as follows.

Cut a 20 μl Aerosol PE barrier Tip 1-3 mm from the filter for each type of CPG. Use in conjunction with a transfer pipet (one for each base) and electric pipet aid to transfer the CPG to each well of an Orochem synthesis filter plate. For standard CPG, prepare the filter plate by adding 0.003 g (40 nmole scale, dry load method) of CPG to each well being used. Be sure to use the CPG-Base (A, T, G, C) that corresponds to the base (A, T, G, C) at the 3′ end of the polynucleotide. Place the Orochem synthesis filter plate in vacuum chuck and bolt down using drill and hex bit. Placing the vacuum chuck such that the waste tube is at the top, well A1 should be in the lower, left corner. The clutch on the drill should be at the minimum torque setting. Tighten bolts diagonally. Using the syringe, wash down the CPG's on the side of each well with acetonitrile. Be careful not to touch the CPG's with the needle to avoid contamination. Cover the plate with a foil seal. Mark on top of foil the wells that contain CPG.

A protocol for setting up a run on the computer is as follows.

First turn on the Welch Teflon Dry vacuum pump. Using the software program select “Home Table” and then “Injection Head Test.” Fill a 21 gauge needle and syringe with dry Acetonitrile. Clean off the ends of the injection lines and keep the ends even. Clear the lines of major debris and air bubbles by selecting “Inject all Left,” “Inject Wash” and “Inject all Right.” Calibrate the valves as described further above. Add fresh phosphorous pentoxide (P₂O₅) to polypropylene (pp) tray to the dry box. On the Align Page of software go to d6 position. Remove old P₂O₅ and old sodium hydroxide (NaOH).

The following setting and run components can be set. On “Cycles”, the following parameters can be set, for example: a) WASH:Prewash, Deblock, Coupling, Capping=1; Interim Deblock=0; Oxidize, Final=2 b) #Deblock Steps=2 c) #Final Deblock Steps=2 d) #2nd Capping Steps=1. Select the plates that will be used in the run. Make sure that the type of CPG is set appropriately, for example, if you are using standard CPG, choose “standard” (standard CPG contains the first base). For Extra Coupling Options, the number of coupling cycles for dA, dG, dT, dC and d5 is 2. The delay between activator and base injections for dA, dG, dT, dC and d5 can be 10 milliseconds. Unless using d6-d10, these should be set at 0. The wait time for coupling can be set to 270 seconds. For polynucleotides that are 5′ phosphorylated, choose DMT ON for these wells. For primers or polynucleotides that do not require this, choose DMT OFF. Check that the nitrogen is flowing and that enough is present to complete the run. The Alicat valves can be set, for example so that the acetonitrile dewar is pressurized at 2.50 psi and the reagent bottles are pressurized at 4.0 psi. Rinse injection heads with acetonitrile using a syringe if necessary to clean off any crystallization and dry. Purge lines by clicking on each injection line individually in order to be sure there are no bubbles in the line leading from the acetonitrile dewar. Check for leaks at valves, reagent bottles, vacuum bottles and lines by visual inspection. When priming, prime one line at a time (that includes the drain waste line). Enter the number or pulses for each injection line. A default setting of 2 on the activator lines and 1 on the amidites and phosphorylating reagent for 30 milliseconds can be used. Place vacuum chuck containing the Orochem synthesis filter plate into position on the machine and hand tighten to make a good seal. Remove foil from wells containing CPGs and perform a wash. Repeat 2-3 times to wash down remaining CPG. Before running the synthesizer, pause until relative humidity (RH) is less than or equal to 1.0% RH. When run is complete, exit out of the program and restart. Return to “Set up Run.” Mix and add 5′ phosphorylating amidite reagent. Note, if there are polynucleotides that are not 5′ phosphorylated, they should have had DMT off on the first run. Prime 5′ line, cap lines, deblock line, associated activator line, oxidizer line and acetonitrile line. Click Run button.

A protocol for the cleavage and deprotection of polynucleotides is as follows.

After synthesis is complete, remove vacuum chuck from the synthesizer and remove the filter plate containing polynucleotides from the chuck. There may be organic waste left in the vacuum chuck after synthesis is complete, so drain the waste before removing the filter plate. Blot the tips of the Orochem synthesis filter plate on a paper towel to remove waste. Check that it is completely dry before proceeding. Place Orochem synthesis filter plate in a deep well, for example, a 2 ml deep well, round bottom, Nunc collection plate. Label the deep well collection plate with the date, polynucleotide batch ID, synthesizer, and number of wells. Add 200 μl of ammonia methyl amine (AMA) (ammonium hydroxide: methyl amine (1:1), stored at 4° C., good for 1 week) to each well and incubate at room temperature for 5 minutes. Ammonium Hydroxide ACS Reagent can be obtained, for example, from Sigma (A-6899), and methylamine 40 wt. % solution in water can be obtained, for example, from Aldrich (42,646-6). Blow through with nitrogen so that CPGs in microwells in filter plate are dry. A rocking motion while applying pressure can facilitate forcing liquid through the filters. Repeat. Add 100 μl AMA directly to the 2.0 ml deep well collection plate. Throw away the Orochem synthesis filter plate containing CPGs. Tightly seal the collection plate, for example, with a clean 96 well Nunc silicone sealer into a custom aluminum heating block chuck. Align another spacer (no depressions) on top of the plate and place in chuck. Tighten screws. Preheat oven to 65° C. Incubate 45 minutes at 65° C. After 45 minutes, remove aluminum heating block chuck from incubator and immediately place in −80° C. freezer for about 1 hour.

A protocol for the lyophilization and resuspension of polynucleotides is as follows.

Place collection plate in Speed Vac with a balance plate. Let both the vapor traps cool down for approximately 24 hours before turning everything else on. Turn on liquid Nitrogen gas boil off from liquid nitrogen dewar (at least 10 psi and the lowest setting) that is purging the oil box of the high vacuum oil pump [10⁻⁴ Torr]. Turn on Speed Vac. The bottom valve should be in the on position, pulling vacuum. When the Speed Vac is at top speed, slowly open the top valve by turning the valve clockwise so that the bleed arrow is on the left. When the plates are dry, slowly bleed the top valve to let air in. Then turn off the Speed Vac and bottom valve. The polynucleotides look like a fluffy white—light yellow plug. Using a multi-channel pipette, add 150 μl sterile, filtered (0.2 micron) and autoclaved 18 megaOhm sterile MilliQ water to each well and seal the plates with foil. Place the polynucleotide plate on the vortex for 30 minutes at a low speed to resuspend.

Each polynucleotide produced can be checked for quality or a sampling of the polynucleotides produced can be selected and tested for quality, for example, on a Beckman P/ACE MDQ 96-well CE, HPLC, or mass spectrometer. The purity is calculated by taking the percent area of the polynucleotide main peak, or N of the CE or HPLC curve.

Quantitation of Oligonucleotides Using the BioTek PowerWave HT

For “stock” plates (non-purified oligos), using a multi-channel pipette, place 3 μl of each oligo into a UV 96-well plate (for example, from Costar) with a calibrated MultiChannel Pipette. For PAGE/Desalted plates, place 10 μl of sample. Add 297 μl 18 MOHM MilliQ sterile water (MQH₂O) to each well (a 1/100 dilution). If blank wells remain in a row, add 300 μl MQH₂O to each well (at least 3 wells). If not, add 300 μl of MQH₂O to the entire next empty row. For a PAGE/Desalted plate, add 90 μl of water for a 1:10 dilution. For a full 96 well plate, load sample and water into A1-G12 on the plate and blank into H1-H12. In another plate, load sample and water into H1-H12 and blank into G1-G12.

Place the plate in a spectrophotometer, for example, the BioTek Spectrophotometer, with A1 in the top right hand corner. Use the software on the spectrophotometer to determine the optical density at wavelengths of 260 and 280 for DNA. A sample protocol, for example, can have the following parameters: Reading Type: Endpoint; Wavelengths: 1=260, 2=280; ReadMode=Normal; Plate: Type=96 well, Size=8×12, First Well=A1, Last Well=H12; Shaking: Intensity=0, Duration=0; Temperature Control: No, Lag Time=00:00:00; PreReadings: Pathlength Correction Wavelengths. For those wells containing Sample+Water, choose Sample in the Type pull-down menu. For those rows containing Blanks, change the Type to Blk. Read plate. The software can create a Microsoft Excel worksheet that can be saved.

A protocol for mass spectrometry analysis of polynucleotides is as follows.

Mass Spec Protocol v.1.1

I. Sample Preparation

Add 150 μl of filtered, autoclaved water 18 MOHM dI water to the lyophilized stock synthesis plate. Seal with foil and shake for 30 minutes until resuspended. Quantitate the oligonucleotides, for example using a BioTek-PowerwaveHT, using the procedure described above. Copy the OD260 pathlength corrected column of the file and paste it into the OD260 column on an Excel file and a CSV file. A csv file is a file used to control the Packard Multiprobe II ex liquid handler. Print out the Excel file and place in the project folder under MALDI. Prepare the Packard for use (see manual).

Open a Packard file “Maldi_water only”. Place a plate, for example an Abgene plate, in the appropriate position on the deck and remove the lid of the water trough. For less then 96 wells, modify the plate outline on the deck. Select “Execute.” Pull in the correct CSV file when prompted. When the Packard water addition is complete, use a multichannel pipette and filter tips to pipette the appropriate amount of stock polynucleotide into the plate. Seal with foil and vortex gently, then briefly spin down in the SpeedVac (no vacuum) or a Beckman plate Centrifuge at 400 g for 60 seconds. Place in 4° C. refrigerator until the next step.

II. Samsung Spotter

Take steps to avoid dust in the spotter. Wipe with a KimWipe and methanol if necessary. Make sure that the two scout plates are free of chips. Open the software program. Check that the Rinse Tank, (Sonicator) Wash Tank and Waste Tank boxes are all green. If not, the feed tank can be filled with deionized water. The (sonicator) wash tank can be filled with a 50:50 solution (by volume) of deionized water and ethanol (or methanol or isopropanol). Empty the waste tank and add enough 100% bleach to just cover the bottom.

Condition the Main Pins:

Select “Home Machine” and then “Pin Conditioning.” Under Sonicator Status, select “Drain Sonicator” and make sure the sonicator bath is emptied. Open the door to access the spotter's deck. Pour 100% ethanol (or methanol or isopropanol) into the sonicator to the top of the bath with a bent nozzle squeeze bottle. Close the door. Close the Pin Conditioning box and close the error log. Select “Pin Conditioning” mainhead or single head and “Start.” The pins will be lowered into the alcohol and conditioned for 30 minutes. When finished, select “Drain Sonicator” and “Fill Sonicator.” The duration of the conditioning can be altered using the software.

To start a normal run—all 96 wells spotted: the following run settings can be used, for example: a) Transfer Definition File: 96 to 96, b) Cycle Run: Auto Run, c) Spotting: Wet Run, d) Operation: Analyte Only, e) Display Warning Message: Timed Display 30 sec, f) Pin Conditioning Time: 30 min. The following Chip Inspection settings can be used, for example: a) Check Auto Inspect Chip Position, b) Check Apply Correction. The following Clean Setting options can be used, for example: a) Clean Cycles: 1 seconds (sec), b) Rinse Time: 3 sec, c) Wash Time: 5 sec, d) Dry Time: 0.2 sec, e) Wash/Supply: 100 sec, e) Turn on (check all) Clean Sequence items—rinse, dry, wash, dry. The following Load/Dispense options can be used, for example: a) Load Time: 3 sec, b) Load Offset: 1 sec, c) Load Speed: 40 mm/sec, d) Disp. Time: 0, e) Disp. Offset: 1, f) Disp. Speed: 80 mm/sec.

Place the MTP containing the sample (at least 50 μl) in the appropriate area. Orient the SCOUT plate so that chip position #1 is in the upper right. The Sequenom logo should be pointing to the left. Place the chip in a chosen spot and select the Start button. For one-to-one spotting with the single pin:

Under Operation Tool, change MTP Type and CHIP Type to 96. The Transfer Definition should be Single Pin Transfer. Select Enable Modify and on the MTP map, select the wells that will be spotted from. Once the appropriate wells on the MTP map have been highlighted, highlight the wells on the chip that these samples are to be spotted to. Once the MTP has bee mapped to the CHIP, select the Save Definition File. On the OPERATION TAB, Run Setup Tab, select Load Method. The following run settings can be used, for example: a) Transfer Definition File: Custom, b) Load SinglePin.def from the Custom Folder. The rest of the settings are the same as for 96 to 96, as described above.

III. Bruker AutoFlex MALDI-TOF/SpectroAcquire RT

A. Bruker AutoFlex/Oligo Check Version 2.0.0.20/SpectroAcquire Version 3.0.1.14

Chose an appropriate method from the Flex Control Method window on the software, for example, for 50-mers, best_test_{—}55 mer.par can be used. For best_test-55 mer.par, IS1=20.00 kV, IS2=18.30 kV, Lens=9.90 kV, Reflector=0.0 kV, Polanty=positive, Detector=limited, PIE=600 ns, suppress up to 1500 Da. On the schematic of the mass spectrometer, point the cursor over the top of the laser. The pressure can be, for example, at 1500-1800 mbar. On the Spectrometer tab, turn the high voltage (HV) OFF. On the MALDI, press the green button on the side to probe out. Put the SCOUT plate containing the chip into the tray. Note the orientation of the tray and close the tray.

Select the RT software and turn on the computer. Open the Mass Array Oligo Check Software. Select Oligo Check Caller, Oligo Check, and Oligo Check Acquirer.

To Do an AutoRun:

On the Bruker AutoFlex, the following procedure can be used. Select Oligo Check and Initialize Maldi Run. In the Initialize Auto Run window, enter the name of the plate, enable chip position, choose the chip position and browse and enter the input file: q:\Maldi\Year\Plate Name_ms. Select Load Maldi Run from database. In the Maldi Run Specifier window, click ALL. Open the tree that appears and select the run name. Select the plate name and highlight the run. Select Submit Maldi Run for Processing and choose SpectroJet if spotting 1:1 or SpectroPoint if all 6 pins were used. For Scoring Mode (SNR), the following parameters can be used, for example, SNR Cutoff: 1, Confidence Level: 0. Back on SpectroAcquire, select Tools, Configure, Mass Spectrometer Method. Select Load Method when starting an autorun. Select Load Parameters from the Tools menu and open the correct parameter file. On the Auto Run Setup Tab, type in the exact name for the run next to the Chip Position it is in. For a more thorough averaging, select “Use all Raster positions.” Select Run.

To analyze:

Select Oligo Check Acquirer. Select Load Maldi Run from Database and navigate to the plate via the tree in the left panel. Look at the traces and record which samples need to be re-spot and re-shot as well as those that failed. If the sample needs to be re-shot, modify the ms file to reflect only those wells that will be re-shot, making sure the mapping is correct. A JPEG file can also be created to store the data.

To Do a Manual Shoot:

On the RT software, select Load Parameters from the Tools menu and select, for example, 50 mer.par. Go to the Manual control tab. Push the green button on the side of the AutoFlex and insert the chip. Push the green button to close. See above for description on chip placement and plate orientation. Input the correct chip position in the Stage Position box. Choose the spot that is to be shot first by well indication (e.g. A1, F3, etc). To save this data, under Raw Data File, select Save Spectrum to a File. Using the arrows by JOG, line up the crosshairs on the spot. Select Acquire.

To Calibrate:

Prepare a 3-point sample, bracketing a length of interest. For example, for a 50-mer, choose 45, 50 and 55. Stock oligos mixed at various concentrations can be used to spot. For example, start with 100 μM for each, then dilute down. For the longest length, more can be added than for the shorter lengths. The goal is to see all three peaks at roughly the same intensity. Spot the 96 chip using the single pin. Follow the directions for single pin spotting on the Samsung Spotter and shoot manually as described further above. Save shots. Review each spectra for resolution and keep, for example, at least 10 spectra.

For each spectra, do the following. Bring the cursor to the spectra and, using the mouse, zoom in on each peak. Left click on the left side of the peak and hold down the left button while dragging over to the right side of the peak. Let go of the button. This will zoom in on the peak. Line the cross hairs up on the apex of the peak until a pointing hand shows up. Left click on the hand. A vertical dashed line will drop down through the apex and a mass will appear on the spectra. Below, a “Peak 1” will be created with an appropriate mass and height. Repeat for the other two peaks. Once this has been done for every peak in the 3 point specta, type in the expected masses. Place the cursor on the main 3 point heading and right click. Select Calibrate Spectrum. A, B and C values will be given. Repeat for all files. Collect and average all of the A, B and C numbers.

Throughout this application various publications have been referenced within parentheses. The disclosures of these publications in their entireties are hereby incorporated by reference in this application in order to more fully describe the state of the art to which this invention pertains.

Although the invention has been described with reference to the disclosed embodiments, those skilled in the art will readily appreciate that the specific experiments detailed are only illustrative of the invention. It should be understood that various modifications can be made without departing from the spirit of the invention. Accordingly, the invention is limited only by the following claims.

What is claimed is:

1. An apparatus for maintaining a closed continuous anhydrous system for automated polynucleotide synthesis, comprising:
a) a plurality of moisture-resistant reagent containers,
b) a dry box capable of forming a seal over a synthesis platform of an automated polynucleotide synthesizer,
c) moisture-resistant tubing connecting said reagent containers to said dry box,
d) a reagent gas feed connecting said reagent containers to a gas, wherein said gas pressurizes said reagent containers, and
e) a digital gas regulator connected to said reagent gas feed, wherein said gas regulator maintains constant pressure in said reagent containers.

2. The apparatus of claim 1, wherein said connections are sealed to exclude moisture entry.

3. The apparatus of claim 2, wherein said sealed connections can maintain a pressure of greater than 100 psi strength.

4. The apparatus of claim 2, wherein said connections are sealed with silicone caulk.

5. The apparatus of claim 1, wherein said reagent containers are nucleotide solution containers or wash solution containers.

6. The apparatus of claim 1, wherein-said gas is nitrogen, argon or helium.

7. The apparatus of claim 1, further comprising a flow through gas dryer connected to said tubing.

8. The apparatus of claim 1 or 7, further comprising a flow through gas dryer connected to said reagent gas feed.

9. The apparatus of claim 1 or 7, further comprising a digital humidity meter inside said dry box.

10. The apparatus of claim 8, further comprising a digital humidity meter inside said dry box.

11. An apparatus for maintaining a closed continuous anhydrous system for automated polynucleotide synthesis, comprising:
a) a plurality of moisture-resistant reagent containers,
b) a dry box capable of forming a seal over a synthesis platform of an automated polynucleotide synthesizer,
c) moisture-resistant tubing connecting said reagent containers to said dry box,
d) a reagent gas feed connecting said reagent containers to a gas, wherein said gas pressurizes said reagent containers,
e) a digital gas regulator connected to said reagent gas feed, wherein said gas regulator maintains constant pressure in said reagent containers, and
f) a polynucleotide synthesizer, device.

12. The apparatus of claim 11, wherein said connections are sealed to exclude moisture entry.

13. The apparatus of claim 12, wherein said sealed connections can maintain a pressure of greater than 100 psi strength.

14. The apparatus of claim 12, wherein said connections are sealed with silicone caulk.

15. The apparatus of claim 11, wherein said reagent containers are nucleotide solution containers or wash solution containers.

16. The apparatus of claim 11, wherein said gas is nitrogen, argon or helium.

17. The apparatus of claim 11, further comprising a flow through gas dryer connected to said tubing.

18. The apparatus of claim 11 or 17, further comprising a flow through gas dryer connected to said reagent gas feed.

19. The apparatus of claim 11 or 17, further comprising a digital humidity meter inside said dry box.

20. The apparatus of claim 18, further comprising a digital humidity meter inside said dry box.
